(19) United States
(12) Patent Application Publication
(10) Pub. No.: US 2023/0343954 A1
(43) Pub. Date: Oct. 26, 2023

(54) CATHODE COATING

(71) Applicant: QuantumScape Battery, Inc., San Jose, CA (US)

(72) Inventors: Zhenfeng YU, San Jose, CA (US); Virgil XU, San Jose, CA (US); Yaosen TIAN, San Jose, CA (US); Yuki KATOH, San Jose, CA (US); Cheng-Chieh CHAO, San Jose, CA (US)

(21) Appl. No.: 18/044,200

(22) PCT Filed: Sep. 8, 2021
(86) PCT No.: PCT/US2021/049528

§ 371 Date: Mar. 6, 2023

Related U.S. Application Data
(60) Provisional application No. 63/075,800, filed on Sep. 8, 2020.
(60) Provisional application No. 63/161,388, filed on Mar. 15, 2021.
(60) Provisional application No. 63/170,321, filed on Apr. 2, 2021.
(60) Provisional application No. 63/173,184, filed on Apr. 9, 2021.

(51) Int. Cl. H01M 4/525; H01M 4/36; H01M 4/505; H01M 10/0525

(52) U.S. Cl. CPC H01M 4/525; H01M 4/366; H01M 4/505; H01M 10/0525; H01M 2004/028

(57) ABSTRACT

Provided herein are new processes for coating a cathode active material with a solution that includes lithium and optionally boron. Also provided herein are new cathode active materials having a coating which includes lithium carbonate and lithium borate. Also provided herein are new cathode active materials having one or two coating thereupon which increase the stability of the cathode active material at high voltage. In some examples, one of the coatings is LiₓZr_{y}O_{z}, wherein 0≤x≤1.6, 0.2≤y≤1.0, and 2≤z≤1.2; LiₓZr_{y}O_{z}, wherein 0.6≤x≤1.5, 0.5≤y≤1.4, and 2.0≤z≤3.7; or LiₓZr_{y}(PO₄)_{z}, wherein 0.05≤x≤1.5, 1≤y≤3, and 2.0≤z≤4.0.

### CROSS-REFERENCE TO RELATED APPLICATIONS

The application claims priority to, and the benefit of, U.S. Provisional Patent Application Nos. 63/075,800, filed Sep. 8, 2020, and titled CATHODE COATING; 63/161,388, filed Mar. 15, 2021, and titled CATHODE COATING; 63/170,321, filed Apr. 2, 2021, and titled CATHODE COATING; and 63/173,184, filed Apr. 9, 2021, and titled CATHODE COATING, the entire contents of each patent application are herein incorporated by reference in their entirety for all purposes.

### FIELD

The present disclosure concerns chemical coatings for cathode active materials, which are useful in cathodes (i.e., positive electrodes) of rechargeable lithium-batteries for reversibly storing lithium ions (Lit).

### BACKGROUND

There is currently an unmet need in the rechargeable lithium battery field directed to cathode active materials which are stable at high voltage (e.g., 4.2 V versus lithium metal) and/or high temperature (e.g., 60° C.). The instability tends to result in increases in internal resistance in the battery, when the battery is stored or when the battery is used, or both.

Solid electrolyte materials tend not to be stable at high voltage or high temperature. Solid electrolyte materials may react with cathode active materials. Cathode active materials may also oxidize when exposed to high voltage or high temperature. These are a few of the reasons for battery performance degradation. Some researchers have tried to coat cathode active materials with LiNbO₃, Li₂ZrO₃, and LiTaO₃ to prevent this oxidative. See for example, US 2016/0156021 A1; US 2019/0044146 A1; and U.S. Pat. No. 9,692,041 B2. See also Chem. Mater. 2018, 30, 22, 8190-8200, (doi.org/10.1021/acs.chemmater.8b03321); Adv. Energy Mater. 2020, 1903778 (doi.org/10.1002/aenm.201903778); and Journal of Power Sources Volume 248, 15 Feb. 2014, Pages 943-950, (doi.org/10.1016/j.jpowsour.2013.10.005). However, these previously reported coatings had poor stability and/or suffered from other disadvantages. For example, at potentials as high as 4.2V (vs Li/Li⁺), the internal resistance of these coatings increased rapidly when in a charged state. For these and other reasons, these previously reported coatings were inferior in several regards.

Set forth herein are solutions to this and other problems in the relevant field.

### SUMMARY

Set forth herein is a composition comprising: a cathode active material; and a coating in contact with the cathode active material, wherein: the coating comprises a member selected from lithium, oxygen, zirconium, phosphorus, or a combination thereof; the coating is amorphous based on x-ray diffraction pattern analysis; the coating comprises crystalline domains based on transmission electron microscopy (TEM) analysis.

Set forth herein is a coated cathode active material, comprising: a cathode active material and a coating in contact with the cathode active material, wherein the coating is characterized as having an x-ray powder diffraction (XRD) pattern having peaks at least at 21.4, 30.3, and 31.7° (±0.5°) (2Θ), when measured using Cu (Kα) radiation at 25° C.; and wherein the peak intensity ratio (k) of the peak at 30.3° degree (2Θ) relative to the peak at 31.7° degree (2Θ) is greater than 1 or less than 2.

Set forth herein is a coated cathode active material, comprising: a cathode active material; wherein the cathode active material comprises a first coating and a second coating; the first coating comprises Li₂CO₃; the second coating comprises Li₃BO₃, Li₃B₁₁O₁₈, LiₓB_{y}O_{z}, or a combination thereof; and wherein the first coating contacts the cathode active material; and the second coating contacts the first coating. In the formula, LiₓB_{y}O_{z}, x is from greater than, or equal to, 0.2, to less than, or equal to, 0.75; y is from greater than, or equal to, 0.5, to less than, or equal to 1.6; and z is from greater than, or equal, to 1.5 to less than, or equal to 2.6. This is equivalently written as LiₓB_{y}O_{z}, wherein 0.2≤x≤0.75, 0.5≤y≤1.6, and 1.5≤z≤2.6.

Also set forth herein is a process for making a coated cathode active material, comprising the following steps: coating a cathode active material with a solution of LiOH; removing the solvent from the solution coating the cathode active material to provide a first material; heating the first material under dry air conditions to form a heated first material; coating the heated first material with a solution of LiOH and a boron source to form a second material; and heating the second material to form a coated cathode active material.

Also set forth herein is a process for making a coated cathode active material, comprising the following steps: coating a cathode active material with a solution of LiOH and a boron source; removing the solvent from the solution coating the cathode active material to provide a coated cathode active material; and heating the coated cathode active material under dry air conditions to form a coated cathode active material.

Also set forth herein is a coated cathode active material, comprising: a cathode active material and a coating in contact with the cathode active material, wherein the coating is characterized as having an x-ray powder diffraction (XRD) pattern having peaks at least at 26.2° and 27.4° (±0.5°) (2Θ), when measured using Cu (Kα) radiation at 25° C.

### BRIEF DESCRIPTIONS OF THE DRAWINGS

FIG. 1 is a schematic illustrating certain differences between certain aspects of the instant disclosure and previously published documents.

FIG. 2 is an x-ray powder diffraction pattern of Examples A, B, C, D, and Comparative Example E.

FIG. 3 are test results from the stability tests in Example 14.

FIG. 4 is a plot summarizing the change in area-specific resistance (AR) for the battery cells tested in Examples 14 and 15.

FIG. 5 shows a scanning electron microscopy image from Example 3.

FIG. 6 shows an x-ray diffraction (XRD) pattern for the crystalline LZO coating prepared in Example 11.

FIG. 7 shows an x-ray diffraction pattern for the amorphous LZO coating prepared in Example 15.

FIG. 8 shows transmission electron microscopy (TEM) image for the LZO-coated active material in Example 15.

### DETAILED DESCRIPTION

Set forth herein are coatings for cathode active materials. In some examples, the cathode active material has one coating. In other examples, the cathode active material has two coatings. In certain examples, the cathode active material with one coating has a crystalline coating, as determined by XRD. In yet other examples, the cathode active material with one coating has an amorphous coating, as determined by XRD. In some examples, a coating on the cathode active material contains lithium, boron, oxygen, or a combination thereof. In some other examples, a coating on the cathode active material contains lithium boron, carbon, oxygen, or a combination thereof. In some other examples, a coating on the cathode active material contains lithium, oxygen, zirconium, phosphorus, or a combination thereof. Certain of these coatings may prevent, or delay, the aforementioned oxidation reactions which were noted as a reason for battery performance degradation. When used in batteries, the newly disclosed coated cathode active materials set forth herein result in more stable batteries.

### DEFINITIONS

As used herein, the term “about,” when qualifying a number, e.g., about 15% w/w, refers to the number qualified and optionally the numbers included in a range about that qualified number that includes ±10% of the number. For example, about 15% w/w includes 15% w/w as well as 13.5% w/w, 14% w/w, 14.5% w/w, 15.5% w/w, 16% w/w, or 16.5% w/w. For example, “about 75° C.,” includes 75° C. as well 68° C., 69° C., 70° C., 71° C., 72° C., 73° C., 74° C., 75° C., 76° C., 77° C., 78° C., 79° C., 80° C., 81° C., 82° C., or 83° C.

As used herein, “selected from the group consisting of” refers to a single member from the group, more than one member from the group, or a combination of members from the group. A member selected from the group consisting of A, B, and C includes, for example, A only, B only, or C only, as well as A and B, A and C, B and C, as well as A, B, and C.

As used herein the phrase “dry air,” refers to air with a reduced amount of humidity. Dry air may be supplied in a clean room. Dry air is characterized as having a dew point less than −70° C.

As used herein the phrase “cathode active material,” refers to a material which can intercalate lithium ions or react with lithium ions in a reversible manner. Examples include LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In these formula, x, y, and z are chosen so that the formula is charge neutral.

As used herein the phrase “characterized as having an x-ray powder diffraction (XRD) pattern having peaks at least at,” means that when the material is analyzed using x-ray powder diffraction, according to the techniques in the Examples, the sample will be observed to have at least the recited XRD peaks and possibly other peaks. Peaks are places of high intensity in the XRD pattern which are indicative of d-spacing (lattice spacing) of the crystalline unit cell which is inducing the observed XRD pattern when x-rays are incident upon the material being analyzed by XRD.

As used herein the phrase “the peak intensity ratio (k) of the peak at 30.3 degree (2Θ) relative to the peak at 31.7 degree (2Θ) is greater than 1 or less than 2,” refers to the ratio of XRD peak intensity (I) at 30.3 degree (2Θ) relative to the peak intensity at 31.7 degree (2Θ): k=I(30.3)/I(31.7).

As used herein the phrase “solid-state cathode refers to a cathode which does not include any liquid-phase electrolytes. As used herein, the terms “cathode” and “anode” refer to the electrodes of a battery. The cathode and anode are often referred to in the relevant field as the positive electrode and negative electrode, respectively. During a charge cycle in a Li-secondary battery, Li ions leave the cathode and move through an electrolyte, to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode. As used herein, the phrase “positive electrode” refers to the electrode in a secondary battery towards which positive ions, e.g., Li⁺, conduct, flow or move during discharge of the battery. As used herein, the phrase “negative electrode” refers to the electrode in a secondary battery from where positive ions, e.g., Li⁺, flow or move during discharge of the battery. In a battery comprised of a Li-metal electrode and a conversion chemistry, intercalation chemistry, or combination conversion/intercalation chemistry-including electrode (i.e., cathode active material; e.g., NiFₓ, NCA, LiNiₓMn_{y}Co_{z}O₂ [NMC] or LiNiₓAl_{y}Co_{z}O₂[NCA], wherein x+y+z =1), the electrode having the conversion chemistry, intercalation chemistry, or combination conversion/intercalation chemistry material is referred to as the positive electrode. In some usages, cathode is used in place of positive electrode, and anode is used in place of negative electrode. When a Li-secondary battery is charged, Li ions move from the positive electrode (e.g., NiFₓ, NMC, NCA) towards the negative electrode (e.g., Li-metal). When a Li-secondary battery is discharged, Li ions move towards the positive electrode and from the negative electrode.

As used herein the phrase “solid separator” refers to a Li+ion-conducting material that is substantially insulating to electrons (e.g., the lithium ion conductivity is at least 103 times, and often 106 times, greater than the electron conductivity), and which acts as a physical barrier or spacer between the positive and negative electrodes in an electrochemical cell.

As used herein, the term “LPSI” refers to a lithium conducting electrolyte comprising Li, P, S, and I. More generally, it is understood to include aLi₂S+bP₂S_{y}+cLiX where X=Cl, Br, and/or I and where y=3-5 and where a/b=2.5-4.5 and where (a+b)/c=0.5-15.

As used herein, “LSTPS” refers to a material characterized by the formula LiₐMP_{b}S_{c}, where M is Si, Ge, Sn, and/or Al, and where 2≤a≤8, 0.5≤b≤2.5, 4≤c≤12. “LSPS” refers to an electrolyte material characterized by the formula LₐSiP_{b}S_{c}, where 2≤a≤8, 0.5≤b≤2.5, 4≤c≤12. LSPS refers to an electrolyte material characterized by the formula LₐSiP_{b}S_{c}, wherein, where 2<a<8, 0.5<b<2.5, 4 <c<12, d<3. Exemplary LSTPS materials are found, for example, in International Patent Application No. PCT/US14/38283, SOLID STATE CATHOLYTE OR ELECTROLYTE FOR BATTERY USING Li_{A}MP_{B}S_{C} (M=SI, GE, AND/OR SN), filed May 15, 2014, and published as WO 2014/186634, on Nov. 20, 2014, which is incorporated by reference herein in its entirety. Exemplary LSTPS materials are found, for example, in U.S. patent application Ser. No. 14/618,979, filed Feb. 10, 2015, and published as Patent Application Publication No. 2015/0171465, on Jun. 18, 2015, which is incorporated by reference herein in its entirety. When M is Sn and Si—both are present. As used herein, “LSTPSO” refers to LSTPS that is doped with, or has, O present. In some examples, “LSTPSO” is a LSTPS material with an oxygen content between 0.01 and 10 atomic %. “LSPS” refers to an electrolyte material having Li, Si, P, and S chemical constituents. As used herein “LSTPS” refers to an electrolyte material having Li, Si, P, Sn, and S chemical constituents. As used herein, “LSPSO” refers to LSPS that is doped with, or has, O present. In some examples, “LSPSO” is a LSPS material with an oxygen content between 0.01 and 10 atomic %. As used herein, “LATP,” refers to an electrolyte material having Li, As, Sn, and P chemical constituents. As used herein “LAGP” refers to an electrolyte material having Li, As, Ge, and P chemical constituents. As used herein, “LSTPSO” refers to a catholyte material characterized by the formula LiₐMP_{b}S_{c}O_{d}, where M is Si, Ge, Sn, and/or Al, and where 2≤a≤8, 0.5≤b≤2.5, 4≤c≤12, d≤3. LSTPSO refers to LSTPS, as defined above, and having oxygen doping at from 0.1 to about 10 atomic %. LPSO refers to LPS, as defined above, and having oxygen doping at from 0.1 to about 10 atomic %.

As used herein, “LTS” refers to a lithium tin sulfide compound which can be described as Li₂S—SnS₂, Li₂S—SnS, Li—S—Sn, and/or a catholyte consisting essentially of Li, S, and Sn. The composition may be LiₓSn_{y}S_{z} where 0.25≤x≤0.65, 0.05≤y≤0.2, and 0.25≤z≤0.65. In some examples, LTS is a mixture of Li₂S and SnS₂ in the ratio of 80:20, 75:25, 70:30, 2:1, or 1:1 molar ratio. LTS may include up to 10 atomic % oxygen. LTS may be doped with Bi, Sb, As, P, B, Al, Ge, Ga, and/or In. As used herein, “LATS” refers to LTS, as used above, and further comprising Arsenic (As).

As used herein the phrase “annealing,” refers heating a material, e.g., from 100° C. to 400° C., or e.g., 100° C., 150° C., 200° C., 250° C., 300° C., or 350° C. in a controlled atmosphere, e.g., dry air.

As used herein the phrase “stable at high voltage,” refers to a material (e.g., a coated cathode active material) which does not react at high voltage (4.2 V or higher versus Li metal) in a way that materially or significantly degrades the ionic conductivity or resistance of the material when held at high voltage for at least three days. Herein, a material or significant degradation in ionic conductivity or resistance is a reduction in ionic conductivity, or an increase in resistance, by an order of magnitude or more. As used herein, the term “high voltage” means at least 4.2V versus lithium metal (i.e., v. Li). High voltage may also refer to higher voltage, e.g., 4.3, 4.4, 4.5, 4.6, 4.7, 4.8. 4.9, 5.0 V or higher.

As used herein, high voltage means 4.2 V or larger versus a lithium metal reference electrode (which is at OV) unless specified to the contrary.

As used herein the phrase “stable at high temperature,” refers to a material (e.g., a coated cathode active material) which does not react at high temperature (60° C. or higher) in a way that materially or significantly degrades the ionic conductivity or resistance of the material when held at high temperature for at least three days.

As used herein, area-specific resistance (ASR) is measured by electrochemical cycling using an Arbin or Biologic instrument unless otherwise specified to the contrary.

As used herein, ionic conductivity is measured by electrical impedance spectroscopy methods known in the art.

Herein, the term “Li—B—C—O,” refers to a material, which may have the empirical formula Li₍₃₋ₓ₎B₍₁₋ₓ₎CₓO₃, wherein 0<x<0.65, and that is isostructural with crystalline Li₂CO₃. In some examples, the XRD pattern for Li—B—C—O indicates the formation of a solid solution with a minor phase distributed in a major phase.

As used herein, the term “LZO” refers to Li₂ZrO₃, ZrO₂, or a combination thereof. LZO may be crystalline, amorphous, or a combination thereof. For example, LZO may include crystalline ZrO₂ and amorphous Li₂ZrO₃. For example, LZO may include ZrO₂. For example, LZO may include Li₂ZrO₃.

### COMPOSITIONS OF MATTER

In certain examples, set forth herein is a composition comprising: a cathode active material; and a coating in contact with the cathode active material, wherein: the coating comprises a member selected from lithium, oxygen, zirconium, phosphorus, or a combination thereof; wherein the coating comprises crystalline domains based on transmission electron microscopy (TEM) analysis.

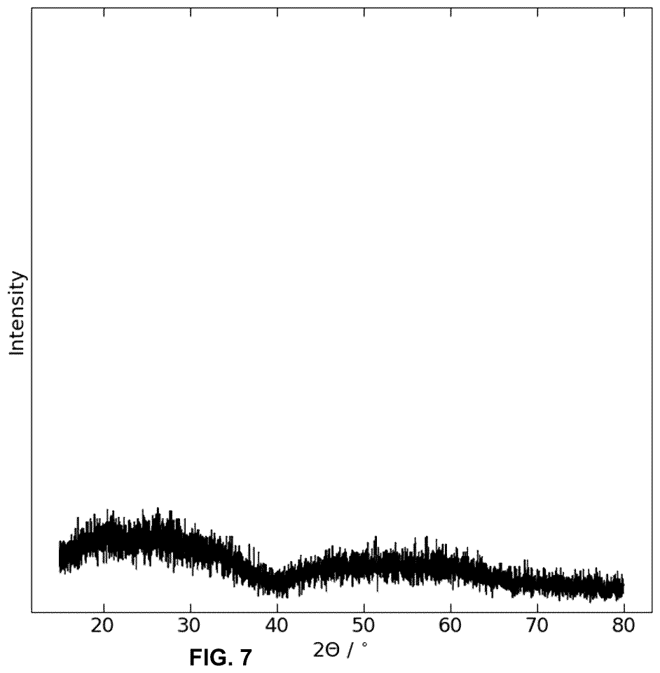

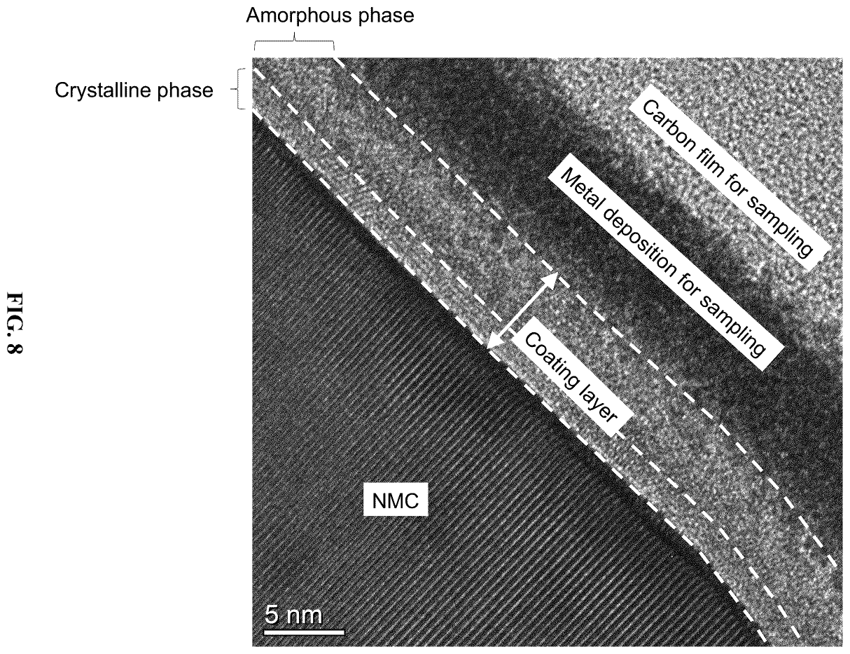

In some of these examples, set forth herein is a composition comprising: a cathode active material; and a coating in contact with the cathode active material, wherein: the coating comprises a member selected from lithium, oxygen, zirconium, phosphorus, or a combination thereof; the coating is amorphous based on x-ray diffraction pattern analysis; the coating comprises crystalline domains based on transmission electron microscopy (TEM) analysis. An example is shown in FIG. 8. In FIG. 8, the coating on the NMC active material has crystalline order as determined by TEM. This crystalline order is adjacent to the NMC active material. FIG. 8 also shows an amorphous component to this coating. Both the crystalline and amorphous components are labeled in FIG. 8. The amorphous component surrounds the crystalline component. As evidenced by FIG. 7, when the coating is analyzed by XRD, the coating appears amorphous on account of the lack of well-defined, high-intensity XRD peaks.

In some examples, including any of the foregoing, the coating has the chemical formula:
LiₓZr_{y}O_{z}, wherein 0≤x≤1.6, 0.2≤y≤1.0, and 2≤z≤1.2;
LiₓP_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0; or
LiₓC_{y}O_{z}, wherein 0.4≤x≤1.8, 0.1≤y≤1, and 1≤z≤1.8.

In certain examples, the coating is LiₓZr_{y}O_{z}, wherein 0≤x≤1.6, 0.2≤y≤1.0, and 2≤z≤1.2.

In certain other examples, the coating is LiₓP_{y}O_{z}, wherein 0.6≤x≤1.5, 0.5≤y≤1.4, and 2.0≤z≤3.7.

In yet other examples, the coating is LiₓZr_{y}(PO₄)_{z}, wherein 0.05≤x≤1.5, 1≤y≤3, and 2.0≤z≤4.0.

In yet other examples, the coating is LiₓC_{y}O_{z}, wherein 0.4≤x≤1.8, 0.1≤y≤1, and 1≤z≤1.8.

In some examples, including any of the foregoing, the coating further comprises amorphous domains based on TEM analysis in addition to the crystalline domains based on transmission electron microscopy analysis.

In some examples, including any of the foregoing, the crystalline domains are in contact with the cathode active material.

In some examples, including any of the foregoing, the amorphous domains are not in contact with the cathode active material.

In some examples, including any of the foregoing, the coating has a thickness, T, as determined by TEM analysis, that is 1 nm≤T≤20 nm.

In some examples, including any of the foregoing, T is about 1, about 5 nm, or about 10 nm. In some examples, including any of the foregoing, T is 1 nm. In some examples, including any of the foregoing, T is 2 nm. In some examples, including any of the foregoing, T is 3 nm. In some examples, including any of the foregoing, T is 4 nm. In some examples, including any of the foregoing, T is 5 nm. In some examples, including any of the foregoing, T is 6 nm. In some examples, including any of the foregoing, T is 7 nm. In some examples, including any of the foregoing, T is 8 nm. In some examples, including any of the foregoing, T is 9 nm. In some examples, including any of the foregoing, T is 10 nm.

In some examples, including any of the foregoing, the coating crystalline domains do not lattice match the crystalline domains of the cathode active material, as determined by TEM analysis.

In some examples, including any of the foregoing, the composition further comprises a second coating in contact with the coating.

In some examples, including any of the foregoing, the second coating has a chemical formula which is not the same as the chemical formula of the coating.

In some examples, including any of the foregoing, the second coating has the chemical formula:
LiₓB_{y}O_{z}, wherein 0.2≤x≤0.75, 0.5≤y≤1.6, and 1.5≤z≤2.6; or
LiₓIn_{y}Cl_{z}, wherein 2≤x<4, 0≤y≤2, and 5≤z≤7.

In some examples, including any of the foregoing, the second coating is amorphous as determined by TEM analysis.

In some examples, including any of the foregoing, the second coating is crystalline as determined by TEM analysis.

In some examples, including any of the foregoing, the second coating is Li₃BO₃.

In some examples, including any of the foregoing, the coating is Li₃InCl₆.

In some examples, including any of the foregoing, the first coating is LiₓZr_{y}O_{z}, wherein 0≤x≤1.6, 0.2≤y≤1.0, and 2≤z≤1.2.

In some examples, including any of the foregoing, the first coating is a lithium zirconium oxide.

In some examples, including any of the foregoing, the first coating is a Li₂ZrO₃.

In some examples, including any of the foregoing, the first coating is LiₓP_{y}O_{z}, wherein 0.6≤x≤1.5, 0.5≤y≤1.4, and 2.0≤z≤3.7.

In some examples, including any of the foregoing, the first coating is Li₃(PO₄).

In some examples, including any of the foregoing, the first coating is LiₓZr_{y}(PO₄)_{z}, wherein 0.05≤x≤1.5, 1≤y≤3, and 2.0≤z≤4.0.

In some examples, including any of the foregoing, the first coating is LiZr₂(PO₄)₃

In some examples, including any of the foregoing, the coating or the second coating, or both, further comprises a member selected from the group consisting of Li₂CO₃, Li₃BO₃, Li₃B₁₁O₁₈, Li₂ZrO₃, Li₃PO₄, Li₂SO₄, LiNbO₃, Li₄Ti₅O₁₂, LiTi₂(PO₄)₃, LiZr₂(PO₄)₃, LiOH, LiF, Li₄ZrF₈, Li₃Zr₄F₁₉, Li₃TiF₆, LiAlF₄, LiYF₄, LiNbF₆, ZrO₂, Al₂O₃, TiO₂, ZrF₄, AlF₃, TiF₄, YF₃, NbF₅, and combinations thereof.

In some examples, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some examples, including any of the foregoing, the cathode active material is LiNiₓMn_{y}Co_{z}O₂, x+y+z=1, 0≤x≤1, 0≤y≤1, and 0≤z≤1.

In some examples, including any of the foregoing, the cathode active material is LiNiₓMn_{y}Co_{z}O₂, x is 0.8, y is 0.1, and z is 0.1.

In some examples, including any of the foregoing, the cathode active material is LiNiₓMn_{y}Co_{z}O₂, x is 0.6, y is 0.2, and z is 0.2.

In some examples, including any of the foregoing, the cathode active material is LiNiₓMn_{y}Co_{z}O₂, x is 0.5, y is 0.3, and z is 0.2.

In some examples, including any of the foregoing, the cathode active material is LiNiₓMn_{y}Co_{z}O₂, x is 1/3, y is 1/3, and z is 1/3.

In some examples, including any of the foregoing, the cathode active material is selected from LiMn2O₄, LiCoO₂, Li(NiCoMn)O₂, and Li(NiCoAl)O₂.

In some examples, set forth herein is a solid-state cathode comprising a coated cathode active material set forth herein.

In some examples, set forth herein is a coated cathode active material, comprising: a cathode active material and a coating in contact with the cathode active material, wherein the coating is characterized as having an x-ray powder diffraction (XRD) pattern having peaks at least at 21.4°, 30.3°, and 31.7° (±0.5°) (2Θ), when measured using Cu (Kα) radiation at 25° C.; and wherein the peak intensity ratio (k) of the peak at 30.3° (2Θ) relative to the peak at 31.7° (2Θ) is greater than 1 or less than 2.

In some examples, including any of the foregoing k is 1.1, 1.2, 1.3, 1.4, 1.5, 1.6, 1.7, 1.8, or 1.9. In some examples, including any of the foregoing k is 1.1. In some examples, including any of the foregoing k is 1.2. In some examples, including any of the foregoing k is 1.3. In some examples, including any of the foregoing k is 1.4. In some examples, including any of the foregoing k is 1.5. In some examples, including any of the foregoing k is 1.6. In some examples, including any of the foregoing k is 1.7. In some examples, including any of the foregoing k is 1.8. In some examples, including any of the foregoing k is 1.9.

In some examples, including any of the foregoing, the coating comprises Li₍₃₋ₓ₎B₍₁₋ₓ₎CₓO₃, wherein 0<x<0.65. In some examples, x is 0.01. In some examples, x is 0.05. In some examples, x is 0.10. In some examples, x is 0.15. In some examples, x is 0.20. In some examples, x is 0.25. In some examples, x is 0.30. In some examples, x is 0.35. In some examples, x is 0.4. In some examples, x is 0.45. In some examples, x is 0.5. In some examples, x is 0.55. In some examples, x is 0.6 In some examples, x is less than 0.65.

In some examples, including any of the foregoing, the coating comprises, or further comprises: LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; LiₓNb_{y}O_{z}, wherein 0.5≤x≤1.5, 0.5≤y≤1.5, and 2≤z≤4; LiₓTi_{y}O_{z}, wherein 0≤x≤1.6, 0.2≤y≤1.0, and 2≤z≤1.2; LiₓTi_{y}P_{w}O_{z}, wherein 0≤x≤2, 1≤y≤3, 1≤w≤4, and 2≤z≤20; LiₓZr_{y}P_{w}O_{z}, wherein 0≤x≤2, 1≤y≤3, 1≤w≤4, and 2≤z≤20; LiₓZr_{y}F_{z}, wherein 0.2≤x≤0.75, 0.25≤y≤0.8, and 1.75≤z≤3.4; LiₓTi_{y}F_{z}, wherein 0.2≤x≤0.75, 0.25≤y≤0.8, and 1.75≤z≤3.4; LiₓAl_{y}F_{z}, wherein 0.4≤x≤0.8, 0.2≤y≤0.6, and 1.4≤z≤2.2; LiₓY_{y}F_{z}, wherein 0.4≤x≤0.8, 0.2≤y≤0.6, and 1.4≤z≤2.2; LiₓNb_{y}F_{z}, wherein 0.2≤x≤0.8, 0.2≤y≤0.8, and 1.8≤z≤4.2; LiₓIn_{y}Cl_{z}, wherein 0.5≤x≤1, 0≤y≤0.5, and 1≤z≤2; LiₓAl_{y}Cl_{z}, wherein 0.5≤x≤1, 0≤y≤0.5, and 1≤z≤2; LiₓY_{y}Cl_{z}, wherein 0.5≤x≤1, 0≤y≤0.5, and 1≤z≤2; LiₓFe_{y}Cl_{z}, wherein 0.5≤x≤1, 0≤y≤0.5, and 1≤z≤2; LiₓZr_{y}Cl_{z}, wherein 0.2≤x≤0.75, 0.25≤y≤0.8, and 1.75≤z≤3.4; LiₓGe_{y}P_{w}O_{z}, wherein 0≤x≤2, 1≤y≤3, 1≤w≤4, and 2≤z≤20; LiₓSn_{y}P_{w}O_{z}, wherein 0≤x≤2, 1≤y≤3, 1≤w≤4, and 2≤z≤20; or a combination thereof.

In some examples, including any of the foregoing, the set forth herein is a coated cathode active material, wherein the coating comprises Li₍₃₋ₓ₎B₍₁₋ₓ₎CₓO₃, wherein 0<x<0.65.

In some examples, including any of the foregoing, the coating comprises, or further comprises LiₓB_{y}O_{z}, wherein 0.2≤x≤0.75, 0.5≤y≤1.6, and 1.5≤z≤2.6.

In some examples, including any of the foregoing, the coating comprises, or further comprises LiₓZr_{y}O_{z}, wherein 0≤x≤1.6, 0.2≤y≤1.0, and 2≤z≤1.2.

In some examples, including any of the foregoing, the coating comprises, or further comprises LiₓP_{y}O_{z}, wherein 0.6≤x≤1.5, 0.5≤y≤1.4, and 2.0≤z≤3.7.

In some examples, including any of the foregoing, the coating comprises, or further comprises LiₓNb_{y}O_{z}, wherein 0.5≤x≤1.5, 0.5≤y≤1.5, and 2≤z≤4.

In some examples, including any of the foregoing, the coating comprises, or further comprises LiₓTi_{y}O_{z}, wherein 0≤x≤1.6, 0.2≤y≤1.0, and 2≤z≤1.2.

In some examples, including any of the foregoing, the coating comprises, or further comprises LiₓTi_{y}P_{w}O_{z}, wherein 0≤x≤2, 1≤y≤3, 1≤w≤4, and 2≤z≤20.

In some examples, including any of the foregoing, the coating comprises, or further comprises LiₓZr_{y}P_{w}O_{z}, wherein 0≤x≤2, 1≤y≤3, 1≤w≤4, and 2≤z≤20.

In some examples, including any of the foregoing, the coating comprises, or further comprises LiₓZr_{y}F_{z}, wherein 0.2≤x≤0.75, 0.25≤y≤0.8, and 1.75≤z≤3.4.

In some examples, including any of the foregoing, the coating comprises, or further comprises LiₓTi_{y}F_{z}, wherein 0.2≤x≤0.75, 0.25≤y≤0.8, and 1.75≤z≤3.4.

In some examples, including any of the foregoing, the coating comprises, or further comprises LiₓAl_{y}F_{z}, wherein 0.4≤x≤0.8, 0.2≤y≤0.6, and 1.4≤z≤2.2.

In some examples, including any of the foregoing, the coating comprises, or further comprises LiₓY_{y}F_{z}, wherein 0.4≤x≤0.8, 0.2≤y≤0.6, and 1.4≤z≤2.2.

In some examples, including any of the foregoing, the coating comprises, or further comprises LiₓNb_{y}F_{z}, wherein 0.2≤x≤0.8, 0.2≤y≤0.8, and 1.8≤z≤4.2.

In some examples, including any of the foregoing, the coating comprises, or further comprises LiₓIn_{y}Cl_{z}, wherein 0.5≤x≤1, 0≤y≤0.5, and 1≤z≤2.

In some examples, including any of the foregoing, the coating comprises, or further comprises LiₓAl_{y}Cl_{z}, wherein 0.5≤x≤1, 0≤y≤0.5, and 1≤z≤2.

In some examples, including any of the foregoing, the coating comprises, or further comprises LiₓY_{y}Cl_{z}, wherein 0.5≤x≤1, 0≤y≤0.5, and 1≤z≤2.

In some examples, including any of the foregoing, the coating comprises, or further comprises LiₓFe_{y}Cl_{z}, wherein 0.5≤x≤1, 0≤y≤0.5, and 1≤z≤2.

In some examples, including any of the foregoing, the coating comprises, or further comprises LiₓZr_{y}Cl_{z}, wherein 0.2≤x≤0.75, 0.25≤y≤0.8, and 1.75≤z≤3.4.

In some examples, including any of the foregoing, the coating comprises, or further comprises LiₓGe_{y}P_{w}O_{z}, wherein 0≤x≤2, 1≤y≤3, 1≤w≤4, and 2≤z≤20.

In some examples, including any of the foregoing, the coating comprises, or further comprises LiₓSn_{y}P_{w}O_{z}, wherein 0≤x≤2, 1≤y≤3, 1≤w≤4, and 2≤z≤20.

In some examples, including any of the foregoing, the coating comprises, or further comprises, Li₂CO₃, Li₃BO_{3,} Li₃B₁₁O₁₈, Li₂ZrO₃, Li₃PO₄, Li₂SO₄, LiNbO₃, Li₄Ti₅O₁₂, LiTi₂(PO₄)₃, LiZr₂(PO₄)₃, LiOH, LiF, Li₄ZrF₈, Li₃Zr₄F₁₉, Li₃TiF₆, LiAlF₄, LiYF₄, LiNbF₆, ZrO₂, Al₂O₃, TiO₂, ZrF₄, A1F₃, TiF₄, YF₃, NbF₅, or a combination thereof.

Unless explicitly stated otherwise, the variables herein are chosen so that the chemical formula is charge neutral.

In some examples, including any of the foregoing, the coating comprises Li₂CO₃, Li3BO₃, Li₃B11O₁₈, LiₓB_{y}O_{z}, or a combination thereof. In the formula, LiₓB_{y}O_{z}, 0.2≤x≤0.75, 0.5≤y≤1.6, and 1.5≤z≤2.6.

In some examples, including any of the foregoing, the coating comprises Li₂CO₃, Li₃BO₃, Li₃B11O₁₈, LiₓB_{y}O_{z}, Li₂ZrO₃, Li₃PO₄, Li₂SO₄, or a combination thereof. In certain examples, the Li₂CO₃ is in contact with the active material. In certain examples, the Li₃BO₃ is in contact with the active material. In certain examples, the Li₃B₁₁O₁₈ is in contact with the active material. In certain examples, the LZO is in contact with the active material. In certain examples, the Li₂ZrO₃ is in contact with the active material. In certain examples, the Li₃PO₄ is in contact with the active material. In certain examples, the Li₂SO₄ is in contact with the active material. In certain examples, the LiₓB_{y}O_{z} is in contact with the active material.

In some examples, including any of the foregoing, the coating comprises, or further comprises, Li₂CO₃, Li₃BO₃, Li₃B11O₁₈, Li₂ZrO₃, Li₃PO₄, Li₂SO₄, LiNbO₃, Li₄Ti₅O₁₂, LiTi₂(PO₄)₃, LiZr₂(PO₄)₃, LiOH, LiF, Li₄ZrF₈, Li₃Zr₄F₁₉, Li₃TiF₆, LiAlF₄, LiYF₄, LiNbF₆, ZrO₂, Al₂O₃, TiO₂, ZrF₄, AlF3, TiF₄, YF₃, NbF₅, or a combination thereof. In certain examples, the coating comprises, or further comprises, Li₂CO₃. In certain examples, the coating comprises, or further comprises, Li₃BO₃. In certain examples, the coating comprises, or further comprises Li₃B11O₁₈. In certain examples, the coating comprises, or further comprises, Li₂ZrO₃. In certain examples, the coating comprises, or further comprises, Li₃PO₄. In certain examples, the coating comprises, or further comprises, Li₂SO₄. In certain examples, the coating comprises, or further comprises, LiNbO₃. In certain examples, the coating comprises, or further comprises, Li₄Ti₅O₁₂. In certain examples, the coating comprises, or further comprises, LiTi₂(PO₄)₃. In certain examples, the coating comprises, or further comprises, LiZr₂(PO₄)₃. In certain examples, the coating comprises, or further comprises, LiOH. In certain examples, the coating comprises, or further comprises, LiF. In certain examples, the coating comprises, or further comprises, Li₄ZrF₈. In certain examples, the coating comprises, or further comprises, Li₃Zr₄F₁₉. In certain examples, the coating comprises, or further comprises, Li₃TiF₆. In certain examples, the coating comprises, or further comprises, LiAlF₄. In certain examples, the coating comprises, or further comprises, LiYF₄. In certain examples, the coating comprises, or further comprises, LiNbF₆. In certain examples, the coating comprises, or further comprises, ZrO₂. In certain examples, the coating comprises, or further comprises, Al₂O₃. In certain examples, the coating comprises, or further comprises, TiO₂. In certain examples, the coating comprises, or further comprises, ZrF₄. In certain examples, the coating comprises, or further comprises, AlF₃. In certain examples, the coating comprises, or further comprises, TiF₄. In certain examples, the coating comprises, or further comprises, YF₃. In certain examples, the coating comprises, or further comprises, NbF₅.

In some examples, including any of the foregoing, the coating is characterized as having an x-ray powder diffraction (XRD) pattern having peaks at 18.9, 21.4, 30.3, 31.7, 33.6, 36.7, 37.2, 39.8, 44.1, 44.9, and 48.7, degrees (2Θ) when measured using Cu (Kα) radiation at 25° C.

In some examples, including any of the foregoing, the coating is characterized as having an x-ray powder diffraction (XRD) pattern having peaks at least at 21.4, 30.3, and 31.7 degrees (2Θ) when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, and 37.2, degrees (2Θ) when measured using Cu (Kα) radiation at 25° C.

In some examples, including any of the foregoing, the coating is characterized as having an x-ray powder diffraction (XRD) pattern having peaks at least at 30.3, 31.7, 33.6, 36.7, and 37.2, degrees (2Θ) when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, 39.8, 44.1, 44.9, and 48.7, degrees (2Θ) when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, and 39.8 degrees (2Θ) when measured using Cu (Kα) radiation at 25° C.

In some examples, including any of the foregoing, the coating is characterized as having an x-ray powder diffraction (XRD) pattern having peaks at least at 18.9, 21.4, 30.3, 31.7, 33.6, 36.7, 37.2, and 39.8 degrees (2Θ) when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, 39.8, 44.1, 44.9, and 48.7 degrees (2Θ) when measured using Cu (Kα) radiation at 25° C.

In some examples, including any of the foregoing, the coating is characterized as having an x-ray powder diffraction (XRD) pattern having peaks at least at 18.9, 21.4, 30.3, 31.7, 33.6, 36.7, 37.2, 39.8, 44.1, 44.9, and 48.7 degrees (2Θ) when measured using Cu (Kα) radiation at 25° C.

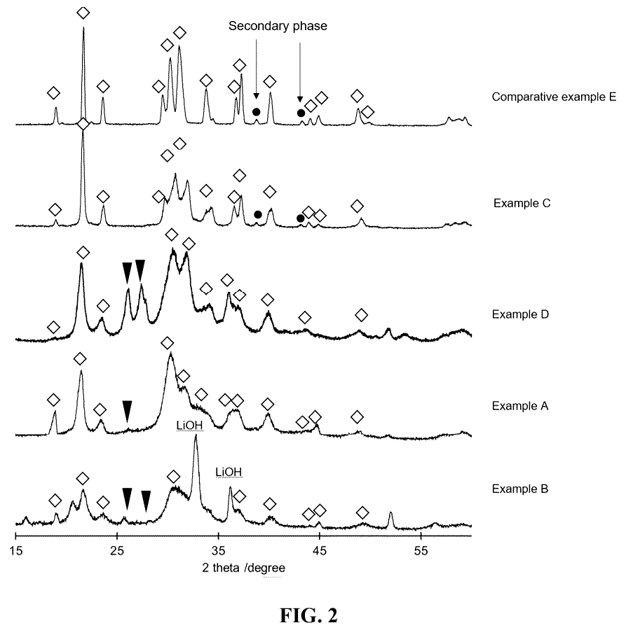

In some examples, including any of the foregoing, the coating is characterized as having an x-ray powder diffraction (XRD) pattern substantially as shown in FIG. 2.

In some examples, including any of the foregoing, the coating is characterized as having an x-ray powder diffraction (XRD) pattern substantially as shown as Example D in FIG. 2.

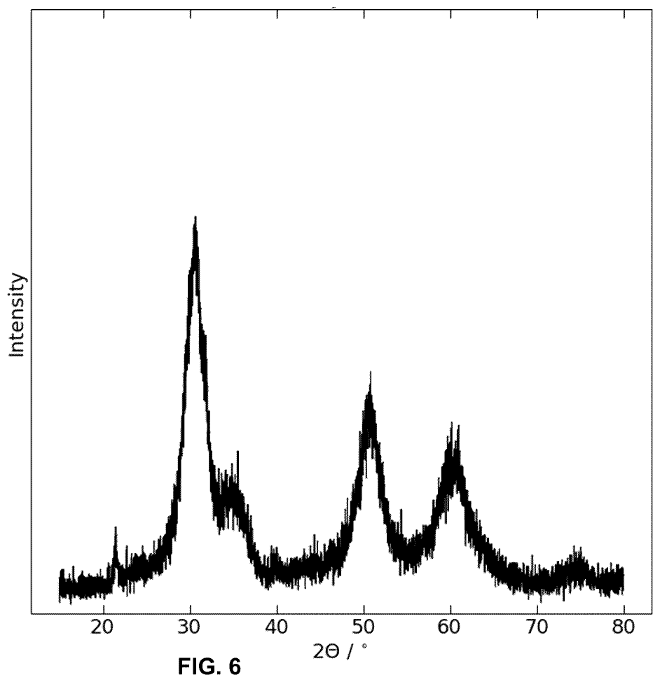

In some examples, including any of the foregoing, the coating is characterized as having an x-ray powder diffraction (XRD) pattern substantially as shown in FIG. 6.

In some examples, including any of the foregoing, the coating is characterized as having an x-ray powder diffraction (XRD) pattern substantially as shown in FIG. 7.

In some examples, including any of the foregoing, the coating comprises Li₃BO₃ and Li₂CO₃, and the molar ratio of LiₓB_{y}O_{z} to Li₂CO₃ is greater than 1. In formula, LiₓB_{y}O_{z}, 0.2≤x≤0.75, 0.5≤y≤1.6, and 1.5≤z≤2.6.

In some examples, including any of the foregoing, the coating comprises Li₃BO₃ and Li₂CO₃, and the molar ratio of LiₓB_{y}O_{z} to Li₂CO₃ is greater than 1 and less than 2.

In some examples, including any of the foregoing, the coating comprises Li₃BO₃ and Li₂CO₃, and the molar ratio of Li₃BO₃ to Li₂CO₃ is greater than 1.

In some examples, including any of the foregoing, the coating comprises Li₃BO₃ and Li₂CO₃, and the molar ratio of Li₃BO₃ to Li₂CO₃ is greater than 1 and less than 2.

In some examples, including any of the foregoing, the coating comprises crystalline Li₃BO₃ and crystalline Li₂CO₃, and the molar ratio of Li₃BO₃ to Li₂CO₃ is greater than 1 and less than 2.

In some examples, including any of the foregoing, the cathode active material is selected from LiMPO₄ (M=Fe, Ni, Co, Mn), LiₓTi_{y}O_{z}, wherein x is from 0 to 8, y is from 1 to 12, z is from 1 to 24, LiMn2O_{4,} LiMn₂ₐNiₐO₄, wherein a is from 0 to 2, LiCoO₂, Li(NiCoMn)O₂, Li(NiCoAl)O₂, and a nickel cobalt aluminum oxide.

In some examples, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In some examples, including any of the foregoing, the cathode active material is LiNiₓMn_{y}Co_{z}O₂, x+y+z=1, 0≤x≤1, 0≤y≤1, and 0≤z≤1. In certain examples, the cathode active material is LiNiₓMn_{y}Co_{z}O₂, x is 0.8, y is 0.1, and z is 0.1. In certain other examples, the coated cathode active material is LiNiₓMn_{y}Co_{z}O₂, x is 0.6, y is 0.2, and z is 0.2. In some examples, the coated cathode active material LiNiₓMn_{y}Co_{z}O₂, x is 0.5, y is 0.3, and z is 0.2. In some other examples, the coated cathode active material is LiNiₓMn_{y}Co_{z}O₂, x is 1/3, y is 1/3, and z is 1/3. In certain examples, the coated cathode active material is selected from LiMn₂O₄, LiCoO₂, Li(NiCoMn)O₂, and Li(NiCoAl)O₂.

In some examples, including any of the foregoing, the cathode active material is LiNiₓMn_{y}Co_{z}O₂, x+y+z=1, 0≤x≤1, 0≤y≤1, and 0≤z≤1. In certain examples, the amount of lithium in the cathode active material will vary depending on the state-of-charge of the battery. For example, the amount of lithium may range from Li_{0.95-1.1(}NiₓMn_{y}Co_{z})O₂, wherein x, y, and z, are as defined above. In certain other examples, the amount of lithium may range from Li_{0.2-1.1(}NiₓMn_{y}Co_{z})O₂, wherein x, y, and z, are as defined above. Other ranges of lithium are contemplated herein.

Unless explicitly stated otherwise, the variables herein are chose so that the chemical formula is charge neutral.

Also set forth herein is a coated cathode active material, comprising: a cathode active material; wherein: the cathode active material comprises a first coating and a second coating; the first coating comprises Li₂CO₃; the second coating comprises Li₃BO₃, Li₃B₁₁O₁₈, LiₓB_{y}O_{z}, wherein 0.2≤x≤0.75, 0.5≤y≤1.6, and 1.5≤z≤2.6, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises LiₓB_{y}O_{z}, wherein 0.2≤x≤0.75, 0.5≤y≤1.6, and 1.5≤z≤2.6, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises Li₃BO₃, Li₃B11O₁₈, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises Li₃BO₃, Li₃B11O₁₈, Li₂ZrO₃, Li₃PO₄, Li₂SO₄, LiₓB_{y}O_{z}, wherein 0.2≤x≤0.75, 0.5≤y≤1.6, and 1.5≤z≤2.6, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises Li₃BO₃, Li₃B11O₁₈, LZO, Li₃PO₄, Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂ZrO₃; the second coating comprises Li₂CO₃, Li₃BO₃, Li₃B11O₁₈, Li₃PO₄, Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LZO; the second coating comprises Li₂CO₃, Li₃BO₃, Li₃B11O₁₈, Li₃PO₄, Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂ZrO₃; the second coating comprises Li₃BO₃; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LZO; the second coating comprises Li₃BO₃; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂Zr₂O₃; the second coating comprises LiₓB_{y}O_{z}, wherein 0.2≤x≤0.75, 0.5≤y≤1.6, and 1.5≤z≤2.6; LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LZO; the second coating comprises LiₓB_{y}O_{z}, wherein 0.2≤x≤0.75, 0.5≤y≤1.6, and 1.5≤z≤2.6; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₃BO₃; the second coating comprises LiₓB_{y}O_{z}, wherein 0.2≤x≤0.75, 0.5≤y≤1.6, and 1.5≤z≤2.6; LiZryO_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiₓB_{y}O_{z}, wherein 0.2≤x≤0.75, 0.5≤y≤1.6, and 1.5≤z≤2.6; and the second coating comprises Li₃BO₃; LiZryO_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₃BO₃; the second coating comprises Li₂CO₃, Li₂ZrO₃, Li₃B11O₁₈, Li₃PO₄, Li₂SO₄, or a combination thereof; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LZO; the second coating comprises Li₃PO_{4;} and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂ZrO₃; the second coating comprises Li₃PO₄; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises LiₓB_{y}O_{z}, wherein 0.2≤x≤0.75, 0.5≤y≤1.6, and 1.5≤z≤2.6; the second coating comprises Li₂SO₄; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₃BO₃; the second coating comprises Li₂SO₄; and wherein: the first coating contacts the cathode active material; and the second coating contacts the first coating.

Also set forth herein is a coated cathode active material, comprising: a cathode active material; wherein: the cathode active material comprises a first coating and a second coating; the first coating comprises Li₂CO₃; the second coating comprises Li₂SO₄; and wherein: the first coating contacts the cathode active material; and the second coating contacts the first coating.

Also set forth herein is a coated cathode active material, comprising: a cathode active material; wherein: the cathode active material comprises a coating LZO; and wherein: the coating contacts the cathode active material.

Also set forth herein is a coated cathode active material, comprising: a cathode active material; wherein: the cathode active material comprises a coating Li₂ZrO₃; and wherein: the coating contacts the cathode active material.

In some examples, including any of the foregoing, the molar ratio of Li₃BO₃ to Li₂CO₃, in the first coating and second coating combined, is greater than 1.

In some examples, including any of the foregoing, the molar ratio of LiₓB_{y}O_{z}, wherein 0.2≤x≤0.75, 0.5≤y≤1.6, and 1.5≤z≤2.6, to Li₂CO₃, in the first coating and second coating combined, is greater than 1.

In some examples, including any of the foregoing, the molar ratio of crystalline LiₓB_{y}O_{z}, wherein 0.2≤x≤0.75, 0.5≤y≤1.6, and 1.5≤z≤2.6, to crystalline Li₂CO₃, in the first coating and second coating combined, is greater than 1 and less than 2.

In some examples, including any of the foregoing, the molar ratio of Li₃BO₃ to Li₂CO₃, in the first coating and second coating combined, is greater than 1 and less than 2.

In some examples, including any of the foregoing, the molar ratio of crystalline Li₃BO₃ to crystalline Li₂CO₃, in the first coating and second coating combined, is greater than 1 and less than 2.

In some examples, including any of the foregoing, the thickness of each coating is about 1 nm to 50 nm. This means that in those examples where a cathode active material has two coatings, each of the two coatings may have a thickness from 1 nm to 50 nm. Each coating may have the same or different thickness as the other coating. In some examples, one of the two coatings has a thickness of 1 nm. In some examples, one of the two coatings has a thickness of 2 nm. In some examples, one of the two coatings has a thickness of 3 nm. In some examples, one of the two coatings has a thickness of 4 nm. In some examples, one of the two coatings has a thickness of 5 nm. In some examples, one of the two coatings has a thickness of 6 nm. In some examples, one of the two coatings has a thickness of 7 nm. In some examples, one of the two coatings has a thickness of 8 nm. In some examples, one of the two coatings has a thickness of 9 nm. In some examples, one of the two coatings has a thickness of 10 nm. In some examples, one of the two coatings has a thickness of 11 nm. In some examples, one of the two coatings has a thickness of 12 nm. In some examples, one of the two coatings has a thickness of 13 nm. In some examples, one of the two coatings has a thickness of 14 nm. In some examples, one of the two coatings has a thickness of 15 nm. In some examples, one of the two coatings has a thickness of 16 nm. In some examples, one of the two coatings has a thickness of 17 nm. In some examples, one of the two coatings has a thickness of 18 nm. In some examples, one of the two coatings has a thickness of 19 nm. In some examples, one of the two coatings has a thickness of 20 nm. In some examples, one of the two coatings has a thickness of 21 nm. In some examples, one of the two coatings has a thickness of 22 nm. In some examples, one of the two coatings has a thickness of 23 nm. In some examples, one of the two coatings has a thickness of 24 nm. In some examples, one of the two coatings has a thickness of 25 nm. In some examples, one of the two coatings has a thickness of 26 nm. In some examples, one of the two coatings has a thickness of 27 nm. In some examples, one of the two coatings has a thickness of 28 nm. In some examples, one of the two coatings has a thickness of 29 nm. In some examples, one of the two coatings has a thickness of 30 nm. In some examples, one of the two coatings has a thickness of 31 nm. In some examples, one of the two coatings has a thickness of 32 nm. In some examples, one of the two coatings has a thickness of 33 nm. In some examples, one of the two coatings has a thickness of 34 nm. In some examples, one of the two coatings has a thickness of 35 nm. In some examples, one of the two coatings has a thickness of 36 nm. In some examples, one of the two coatings has a thickness of 37 nm. In some examples, one of the two coatings has a thickness of 38 nm. In some examples, one of the two coatings has a thickness of 39 nm. In some examples, one of the two coatings has a thickness of 40 nm. In some examples, one of the two coatings has a thickness of 41 nm. In some examples, one of the two coatings has a thickness of 42 nm. In some examples, one of the two coatings has a thickness of 43 nm. In some examples, one of the two coatings has a thickness of 44 nm. In some examples, one of the two coatings has a thickness of 45 nm. In some examples, one of the two coatings has a thickness of 46 nm. In some examples, one of the two coatings has a thickness of 47 nm. In some examples, one of the two coatings has a thickness of 48 nm. In some examples, one of the two coatings has a thickness of 49 nm. In some examples, one of the two coatings has a thickness of 50 nm. In some examples, the second of the two coatings has a thickness of 1 nm. In some examples, the second of the two coatings has a thickness of 2 nm. In some examples, the second of the two coatings has a thickness of 3 nm. In some examples, the second of the two coatings has a thickness of 4 nm. In some examples, the second of the two coatings has a thickness of 5 nm. In some examples, the second of the two coatings has a thickness of 6 nm. In some examples, the second of the two coatings has a thickness of 7 nm. In some examples, the second of the two coatings has a thickness of 8 nm. In some examples, the second of the two coatings has a thickness of 9 nm. In some examples, the second of the two coatings has a thickness of 10 nm. In some examples, the second of the two coatings has a thickness of 11 nm. In some examples, the second of the two coatings has a thickness of 12 nm. In some examples, the second of the two coatings has a thickness of 13 nm. In some examples, the second of the two coatings has a thickness of 14 nm. In some examples, the second of the two coatings has a thickness of 15 nm. In some examples, the second of the two coatings has a thickness of 16 nm. In some examples, the second of the two coatings has a thickness of 17 nm. In some examples, the second of the two coatings has a thickness of 18 nm. In some examples, the second of the two coatings has a thickness of 19 nm. In some examples, the second of the two coatings has a thickness of 20 nm. In some examples, the second of the two coatings has a thickness of 21 nm. In some examples, the second of the two coatings has a thickness of 22 nm. In some examples, the second of the two coatings has a thickness of 23 nm. In some examples, the second of the two coatings has a thickness of 24 nm. In some examples, the second of the two coatings has a thickness of 25 nm. In some examples, the second of the two coatings has a thickness of 26 nm. In some examples, the second of the two coatings has a thickness of 27 nm. In some examples, the second of the two coatings has a thickness of 28 nm. In some examples, the second of the two coatings has a thickness of 29 nm. In some examples, the second of the two coatings has a thickness of 30 nm. In some examples, the second of the two coatings has a thickness of 31 nm. In some examples, the second of the two coatings has a thickness of 32 nm. In some examples, the second of the two coatings has a thickness of 33 nm. In some examples, the second of the two coatings has a thickness of 34 nm. In some examples, the second of the two coatings has a thickness of 35 nm. In some examples, the second of the two coatings has a thickness of 36 nm. In some examples, the second of the two coatings has a thickness of 37 nm. In some examples, the second of the two coatings has a thickness of 38 nm. In some examples, the second of the two coatings has a thickness of 39 nm. In some examples, the second of the two coatings has a thickness of 40 nm. In some examples, the second of the two coatings has a thickness of 41 nm. In some examples, the second of the two coatings has a thickness of 42 nm. In some examples, the second of the two coatings has a thickness of 43 nm. In some examples, the second of the two coatings has a thickness of 44 nm. In some examples, the second of the two coatings has a thickness of 45 nm. In some examples, the second of the two coatings has a thickness of 46 nm. In some examples, the second of the two coatings has a thickness of 47 nm. In some examples, the second of the two coatings has a thickness of 48 nm. In some examples, the second of the two coatings has a thickness of 49 nm. In some examples, the second of the two coatings has a thickness of 50 nm.

In some examples, including any of the foregoing, the coatings are characterized as having an x-ray powder diffraction (XRD) pattern having peaks at 21.4, 30.3, and 31.7 (±0.5°) (2Θ), when measured using Cu (Kα) radiation at 25° C.; and wherein the peak intensity ratio (k) of the peak at 30.3 degree (2Θ) relative to the peak at 31.7 degree (2Θ) is greater than 1 or less than 2.

In some examples, including any of the foregoing, the coating is characterized as having an x-ray powder diffraction (XRD) pattern having peaks at 18.9, 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern having peaks at least at 21.4, 30.3, and 31.7 when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, and 37.2, when measured using Cu (Kα) radiation at 25° C.

In some examples, including any of the foregoing, the coating is characterized as having an x-ray powder diffraction (XRD) pattern having peaks at least at 30.3, 31.7, 33.6, 36.7, and 37.2, when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, and 39.8, when measured using Cu (Kα) radiation at 25° C.

In some examples, including any of the foregoing, the coating is characterized as having an x-ray powder diffraction (XRD) pattern having peaks at least at 18.9, 21.4, 30.3, 31.7, 33.6, 36.7, 37.2, and 39.8, when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern having peaks at least at 18.9, 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern substantially as shown in FIG. 2.

In some examples, including any of the foregoing, the coating is characterized as having an x-ray powder diffraction (XRD) pattern substantially as shown as Example D in FIG. 2.

In some examples, including any of the foregoing, the coating is characterized as having an x-ray powder diffraction (XRD) pattern substantially as shown in FIG. 6.

In some examples, including any of the foregoing, the coating is characterized as having an x-ray powder diffraction (XRD) pattern substantially as shown in FIG. 7.

In some examples, set forth herein is a coated cathode active material, comprising: a cathode active material and a coating in contact with the cathode active material, wherein the coating is characterized as having an x-ray powder diffraction (XRD) pattern having peaks at least at 21.4°, 30.3°, and 31.7° (±0.5°) (2Θ), when measured using Cu (Kα) radiation at 25° C.; and wherein the peak intensity ratio (k) of the peak at 30.3 degree (2Θ) relative to the peak at 31.7° (2Θ) is greater than 1 or less than 2; optionally wherein the coating comprises Li₍₃₋ₓ₎B₍₁₋ₓ₎CₓO₃, wherein 0<x<0.65; and wherein the coating comprises, or further comprises a member selected from:
LiₓB_{y}O_{z}, wherein 0.2≤x≤0.75, 0.5≤y≤1.6, and 1.5≤z≤2.6;
LiₓC_{y}O_{z}, wherein 0.4≤x≤1.8, 0.1≤y≤1, and 1≤z≤1.8;
LiₓZr_{y}O_{z}, wherein 0≤x≤1.6, 0.2≤y≤1.0, and 2≤z≤1.2;
LiₓZr_{y}(PO₄)_{z}, wherein 0.05≤x≤1.5, 1≤y≤3, and 2.0≤z≤4.0;
LiₓP_{y}O_{z}, wherein 0.6≤x≤1.5, 0.5≤y≤1.4, and 2.0≤z≤3.7;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓY_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2;
LiₓIn_{y}Cl_{z}, wherein 0.5≤x≤1, 0≤y≤0.5, and 1≤z≤2;
LiₓAl_{y}Cl_{z}, wherein 0.5≤x≤1, 0≤y≤0.5, and 1≤z≤2;
LiₓY_{y}Cl_{z}, wherein 0.5≤x≤1, 0≤y≤0.5, and 1≤z≤2;
LiₓFe_{y}Cl_{z}, wherein 0.5≤x≤1, 0≤y≤0.5, and 1≤z≤2;
LiₓZr_{y}Cl_{z}, wherein 0.2≤x≤0.75, 0.25≤y≤0.8, and 1.75≤z≤3.4;
LiₓGe_{y}P_{w}O_{z}, wherein 0≤x≤2, 1≤y≤3, 1≤w≤4, and 2≤z≤20;
LiₓSn_{y}P_{w}O_{z}, wherein 0≤x≤2, 1≤y≤3, 1≤w≤4, and 2≤z≤20; or
a combination thereof.

In some examples, set forth herein is a coated cathode active material, comprising: a cathode active material; wherein: the cathode active material comprises a first coating and a second coating; the first coating comprises Li₂CO₃; the first coating contacts the cathode active material; and the second coating contacts the first coating; the second coating comprises, or further comprises a member selected from:
LiₓB_{y}O_{z}, wherein 0.2≤x≤0.75, 0.5≤y≤1.6, and 1.5≤z≤2.6;
LiₓC_{y}O_{z}, wherein 0.4≤x≤1.8, 0.1≤y≤1, and 1≤z≤1.8;
LiₓZr_{y}O_{z}, wherein 0≤x≤1.6, 0.2≤y≤1.0, and 2≤z≤1.2;
LiₓP_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓY_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2; or
a combination thereof.

In some examples, set forth herein is a coated cathode active material, comprising: a cathode active material; wherein: the cathode active material comprises a first coating and a second coating; the first coating contacts the cathode active material; and the second coating contacts the first coating; the either the first coating, the second coating, or both, individually in each instance comprises:
LiₓB_{y}O_{z}, wherein 0.2≤x≤0.75, 0.5≤y≤1.6, and 1.5≤z≤2.6;
LiₓC_{y}O_{z}, wherein 0.4≤x≤1.8, 0.1≤y≤1, and 1≤z≤1.8;
LiₓZr_{y}O_{z}, wherein 0≤x≤1.6, 0.2≤y≤1.0, and 2≤z≤1.2;
LiₓP_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓY_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2;
LiₓIn_{y}Cl_{z}, wherein 0.5≤x≤1, 0≤y≤0.5, and 1≤z≤2;
LiₓAl_{y}Cl_{z}, wherein 0.5≤x≤1, 0≤y≤0.5, and 1≤z≤2;
LiₓY_{y}Cl_{z}, wherein 0.5≤x≤1, 0≤y≤0.5, and 1≤z≤2;
LiₓFe_{y}Cl_{z}, wherein 0.5≤x≤1, 0≤y≤0.5, and 1≤z≤2;
LiₓZr_{y}Cl_{z}, wherein 0.2≤x≤0.75, 0.25≤y≤0.8, and 1.75≤z≤3.4;
LiₓGe_{y}P_{w}O_{z}, wherein 0≤x≤2, 1≤y≤3, 1≤w≤4, and 2≤z≤20;
LiₓSn_{y}P_{w}O_{z}, wherein 0≤x≤2, 1≤y≤3, 1≤w≤4, and 2≤z≤20; or
a combination thereof.

In some examples, including any of the foregoing, the cathode active material is selected from LiMPO₄ (M=Fe, Ni, Co, Mn), LiₓTi_{y}O_{z}, wherein x is from 0 to 8, y is from 1 to 12, z is from 1 to 24, LiMn2O₄, LiMn₂ₐNiₐO₄, wherein a is from 0 to 2, LiCoO₂, Li(NiCoMn)O₂, Li(NiCoAl )O₂, and Nickel Cobalt Aluminum Oxides.

In some examples, including any of the foregoing, the cathode active material comprises Li₍₃₋ₓ₎B₍₁₋ₓ₎CₓO₃, wherein 0≤x≤0.65, at the coating or the coating interface.

In some other examples, set forth herein is a solid-state cathode comprising a coated cathode active material set forth herein.

In some examples, including any of the foregoing, the solid-state cathode comprises a solid-state electrolyte selected from the group consisting of Li₂S—SiS₂, Li₂S—SiS₂—LiI, Li₂S—SiS₂—Li₃MO₄, Li₂S—SiS₂—Li₃MO₃, Li₂S—P₂S₅—LiI, and LATS, where M is a member selected from the group consisting of Si, P, Ge, B, Al, Ga, and In.

In some examples, including any of the foregoing, the solid-state cathode comprises LSTPS or LPSI.

In some other examples, set forth herein is a battery comprising a solid-state cathode set forth herein, a solid separator and an anode.

Also set forth herein is a coated cathode active material, comprising: a cathode active material and a coating in contact with the cathode active material, wherein the coating is characterized as having an x-ray powder diffraction (XRD) pattern having peaks at least at 26.2° and 27.4° (±0.5°) (2Θ), when measured using Cu (Kα) radiation at 25° C.

In some examples, including any of the foregoing, the cathode active material is selected from LiMPO₄ (M=Fe, Ni, Co, Mn), LiₓTi_{y}O_{z}, wherein x is from 0 to 8, y is from 1 to 12, z is from 1 to 24, LiMn2O₄, LiMn₂ₐNiₐO₄, wherein a is from 0 to 2, LiCoO₂, Li(NiCoMn)O₂, Li(NiCoAl)O₂, and a nickel cobalt aluminum oxide.

In some examples, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1. In some examples, including any of the foregoing, the cathode active material is LiNiₓMn_{y}Co_{z}O₂, x+y+z=1, 0≤x≤1, 0≤y≤1, and 0≤z≤1. In certain examples, the cathode active material is LiNiₓMn_{y}Co_{z}O₂, x is 0.8, y is 0.1, and z is 0.1. In certain other examples, the coated cathode active material is LiNiₓMn_{y}Co_{z}O₂, x is 0.6, y is 0.2, and z is 0.2. In some other examples, the coated cathode active material is LiNiₓMn_{y}Co_{z}O₂, x is 0.5, y is 0.3, and z is 0.2. In other examples, the coated cathode active material is LiNiₓMn_{y}Co_{z}O₂, x is 1/3, y is 1/3, and z is 1/3. In some examples, the coated cathode active material is selected from LiMn2O₄, LiCoO₂, Li(NiCoMn)O₂, and Li(NiCoAl)O₂.

In some examples, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some examples, including any of the foregoing, the cathode active material is LiNiₓMn_{y}Co_{z}O₂, x+y+z=1, 0≤x≤1, 0≤y≤1, and 0≤z≤1.

In some examples, including any of the foregoing, the cathode active material is LiNiₓMn_{y}Co_{z}O₂, x is 0.8, y is 0.1, and z is 0.1.

In some examples, including any of the foregoing, the cathode active material is LiNiₓMn_{y}Co_{z}O₂, x is 0.6, y is 0.2, and z is 0.2.

In some examples, including any of the foregoing, the cathode active material is LiNiₓMn_{y}Co_{z}O₂, x is 0.5, y is 0.3, and z is 0.2.

In some examples, including any of the foregoing, the cathode active material is LiNiₓMn_{y}Co_{z}O₂, x is 1/3, y is 1/3, and z is 1/3.

In some examples, including any of the foregoing, the cathode active material is selected from LiMn2O₄, LiCoO₂, Li(NiCoMn)O₂, and Li(NiCoAl)O₂.

In some examples, set forth herein is a coated cathode active material, comprising: a cathode active material; wherein: the cathode active material comprises a first coating and a second coating; the first coating comprises Li₂CO₃; the second coating comprises Li₃BO₃, Li₃B₁₁O₁₈, or a combination thereof; and wherein: the first coating contacts the cathode active material; and the second coating contacts the first coating.

In some examples, including any of the foregoing, the molar ratio of Li₃BO₃ to Li₂CO₃, in the first coating and second coating combined, is greater than 1.

In some examples, including any of the foregoing, the molar ratio of Li₃BO₃ to Li₂CO₃, in the first coating and second coating combined, is greater than 1 and less than 2.

In some examples, including any of the foregoing, the molar ratio of crystalline Li₃BO₃ to crystalline Li₂CO₃, in the first coating and second coating combined, is greater than 1 and less than 2.

In some examples, including any of the foregoing, the coatings are characterized as having an x-ray powder diffraction (XRD) pattern having peaks at 21.4, 30.3, and 31.7 (±0.5°) (2Θ), when measured using Cu (Kα) radiation at 25° C.; and wherein the peak intensity ratio (k) of the peak at 30.3 degree (2Θ) relative to the peak at 31.7 degree (2Θ) is greater than 1 or less than 2.

In some examples, set forth herein is a coated cathode active material, comprising: a cathode active material; wherein: the cathode active material comprises a first coating and a second coating; the first coating comprises Li₂CO₃; the second coating comprises LiₓZr_{y}O_{z}, wherein 0≤x≤1.6, 0.2≤y≤1.0, and 2≤z≤1.2; LiₓP_{y}O_{z}, wherein 0.6≤x≤1.5, 0.5≤y≤1.4, and 2.0≤z≤3.7; or LiₓZr_{y}(PO₄)_{z}, wherein 0.05≤x≤1.5, 1≤y≤3, and 2.0≤z≤4.0.

In some examples, including any of the foregoing, the cathode active material is selected from LiMPO₄ (M=Fe, Ni, Co, Mn), LiₓTi_{y}O_{z}, wherein x is from 0 to 8, y is from 1 to 12, z is from 1 to 24, LiMn₂ₐNiₐO₄, wherein a is from 0 to 2, and nickel cobalt aluminum oxides.

In some examples, including any of the foregoing, the cathode active material is LiNiₓMn_{y}Co_{z}O₂, x+y+z=1, 0≤x≤1, 0≤y≤1, and 0≤z≤1.

In some examples, including any of the foregoing, the cathode active material is LiNiₓMn_{y}Co_{z}O₂, x is 0.8, y is 0.1, and z is 0.1.

In some examples, including any of the foregoing, the cathode active material is LiNiₓMn_{y}Co_{z}O₂, x is 0.6, y is 0.2, and z is 0.2.

In some examples, including any of the foregoing, the cathode active material is LiNiₓMn_{y}Co_{z}O₂, x is 0.5, y is 0.3, and z is 0.2.

In some examples, including any of the foregoing, the cathode active material is LiNiₓMn_{y}Co_{z}O₂, x is 1/3, y is 1/3, and z is 1/3.

In some examples, including any of the foregoing, the cathode active material is selected from LiMn2O₄, LiCoO₂, Li(NiCoMn)O₂, and Li(NiCoAl)O₂.

In some examples, including any of the foregoing, the cathode active material comprises Li₍₃₋ₓ₎B₍₁₋ₓ₎CₓO₃, wherein 0≤x≤0.65, at the coating or the coating interface.

In some other examples, set forth herein is a solid-state cathode comprising a coated cathode active material set forth herein.

In some examples, including any of the foregoing, the solid-state cathode further comprises a solid-state electrolyte selected from the group consisting of Li₂S—SiS₂, Li₂S—SiS₂—LiI, Li₂S—SiS₂—Li₃MO₄, Li₂S—SiS₂—Li₃MO₃, Li₂S—P2S₅—LiI, and LATS, where M is a member selected from the group consisting of Si, P, Ge, B, Al, Ga, and In.

In some examples, including any of the foregoing, the solid electrolyte comprises LSTPS or LPSI.

In certain examples, set forth herein is a battery comprising a solid-state cathode, set forth herein, a solid separator and an anode.

In certain examples, set forth herein is a coated cathode active material, comprising: a cathode active material and a coating in contact with the cathode active material, wherein the coating is characterized as having an x-ray powder diffraction (XRD) pattern having peaks at least at 26.2° and 27.4° (±0.5°) (2Θ), when measured using Cu (Kα) radiation at 25° C.

In some examples, including any of the foregoing, the coating comprises Li₃BO₃ and Li₂CO₃.

In some examples, including any of the foregoing, the coating comprises Li₂ZrO₃ and Li₃PO₄.

In some examples, including any of the foregoing, the Li₂ZrO₃ is in contact with the active material.

In some examples, including any of the foregoing, the coating comprises Li₃BO₃ and Li₂SO₄.

In some examples, including any of the foregoing, the Li₃BO₃ is in contact with the active material.

and Li₂SO₄.

In some examples, including any of the foregoing, the coating comprises Li₂CO₃

In some examples, including any of the foregoing, the Li₂CO₃ is in contact with the active material.

In some examples, including any of the foregoing, the coating comprises Li₂ZrO₃.

In some examples, including any of the foregoing, the Li₂ZrO₃ is in contact with the active material.

In some examples, including any of the foregoing, the thickness of each coating is about 1 nm to 50 nm.

In some examples, set forth herein is a coated cathode active material, comprising: a cathode active material and a coating in contact with the cathode active material, wherein the coating is characterized as having an x-ray powder diffraction (XRD) pattern having peaks at least at 21.4°, 30.3°, and 31.7° (±0.5°) (2Θ), when measured using Cu (Kα) radiation at 25° C.; and wherein the peak intensity ratio (k) of the peak at 30.3 degree (2Θ) relative to the peak at 31.7 degree (2Θ) is greater than 1 or less than 2; optionally wherein the coating comprises Li₍₃₋ₓ₎B₍₁₋ₓ₎CₓO₃, wherein 0≤x≤0.65; and wherein the coating comprises, or further comprises:
LiₓB_{y}O_{z}, wherein 0.2≤x≤0.75, 0.5≤y≤1.6, and 1.5≤z≤2.6;
LiₓZr_{y}O_{z}, wherein 0≤x≤1.6, 0.2≤y≤1.0, and 2≤z≤1.2;
LiₓZr_{y}(PO₄)_{z}, wherein 0.05≤x≤1.5, 1≤y≤3, and 2.0≤z≤4.0;
LiₓP_{y}O_{z}, wherein 0.6≤x≤1.5, 0.5≤y≤1.4, and 2.0≤z≤3.7;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓA_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2;
LiₓIn_{y}Cl_{z}, wherein 0.5≤x≤1, 0≤y≤0.5, and 1≤z≤2;
LiₓAl_{y}Cl_{z}, wherein 0.5≤x≤1, 0≤y≤0.5, and 1≤z≤2;
LiₓY_{y}Cl_{z}, wherein 0.5≤x≤1, 0≤y≤0.5, and 1≤z≤2;
LiₓFe_{y}Cl_{z}, wherein 0.5≤x≤1, 0≤y≤0.5, and 1≤z≤2;
LiₓZr_{y}Cl_{z}, wherein 0.2≤x≤0.75, 0.25≤y≤0.8, and 1.75≤z≤3.4;
LiₓGe_{y}P_{w}O_{z}, wherein 0≤x≤2, 1≤y≤3, 1≤w≤4, and 2≤z≤20;
LiₓSn_{y}P_{w}O_{z}, wherein 0≤x≤2, 1≤y≤3, 1≤w≤4, and 2≤z≤20; or
a combination thereof.

In some examples, set forth herein is a coated cathode active material, comprising: a cathode active material; wherein: the cathode active material comprises a first coating and a second coating; the first coating comprises Li₂CO₃; the first coating contacts the cathode active material; and the second coating contacts the first coating; the second coating comprises, or further comprises:
LiₓB_{y}O_{z}, wherein 0.2≤x≤0.75, 0.5≤y≤1.6, and 1.5≤z≤2.6;
LiₓZr_{y}O_{z}, wherein 0≤x≤1.6, 0.2≤y≤1.0, and 2≤z≤1.2;
LiₓT_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓY_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2; or a combination thereof.

A coated cathode active material, comprising: a cathode active material; wherein: the cathode active material comprises a first coating and a second coating; the first coating contacts the cathode active material; and the second coating contacts the first coating; the either the first coating, the second coating, or both, individually in each instance comprises:
LiₓB_{y}O_{z}, wherein 0.2≤x≤0.75, 0.5≤y≤1.6, and 1.5≤z≤2.6;
LiₓZr_{y}O_{z}, wherein 0≤x≤1.6, 0.2≤y≤1.0, and 2≤z≤1.2;
LiₓT_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0;
LiₓNb_{y}O_{z}, wherein 0.5≤x≤1.5, 0.5≤y≤1.5, and 2≤z≤4;
LiₓTi_{y}O_{z}, wherein 0≤x≤1.6, 0.2≤y≤1.0, and 2≤z≤1.2;
LiₓTi_{y}P_{w}O_{z}, wherein 0≤x≤2, 1≤y≤3, 1≤w≤4, and 2≤z≤20;
LiₓZr_{y}P_{w}O_{z}, wherein 0≤x≤2, 1≤y≤3, 1≤w≤4, and 2≤z≤20;
LiₓZr_{y}F_{z}, wherein 0.2≤x≤0.75, 0.25≤y≤0.8, and 1.75≤z≤3.4;
LiₓTi_{y}F_{z}, wherein 0.2≤x≤0.75, 0.25≤y≤0.8, and 1.75≤z≤3.4;
LiₓAl_{y}F_{z}, wherein 0.4≤x≤0.8, 0.2≤y≤0.6, and 1.4≤z≤2.2;
LiₓA_{y}F_{z}, wherein 0.4≤x≤0.8, 0.2≤y≤0.6, and 1.4≤z≤2.2;
LiₓNb_{y}F_{z}, wherein 0.2≤x≤0.8, 0.2≤y≤0.8, and 1.8≤z≤4.2;
LiₓIn_{y}Cl_{z}, wherein 0.5≤x≤1, 0≤y≤0.5, and 1≤z≤2;
LiₓAl_{y}Cl_{z}, wherein 0.5≤x≤1, 0≤y≤0.5, and 1≤z≤2;
LiₓY_{y}Cl_{z}, wherein 0.5≤x≤1, 0≤y≤0.5, and 1≤z≤2;
LiₓFe_{y}Cl_{z}, wherein 0.5≤x≤1, 0≤y≤0.5, and 1≤z≤2;
LiₓZr_{y}Cl_{z}, wherein 0.2≤x≤0.75, 0.25≤y≤0.8, and 1.75≤z≤3.4;
LiₓGe_{y}P_{w}O_{z}, wherein 0≤x≤2, 1≤y≤3, 1≤w≤4, and 2≤z≤20;
LiₓSn_{y}P_{w}O_{z}, wherein 0≤x≤2, 1≤y≤3, 1≤w≤4, and 2≤z≤20;
or a combination thereof.

In some examples, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some examples, including any of the foregoing, the cathode active material is LiNiₓMn_{y}Co_{z}O₂, x+y+z=1, 0≤x≤1, 0≤y≤1, and 0≤z≤1.

In some examples, including any of the foregoing, the cathode active material is LiNiₓMn_{y}Co_{z}O₂, x is 0.8, y is 0.1, and z is 0.1.

In some examples, including any of the foregoing, the cathode active material is LiNiₓMn_{y}Co_{z}O₂, x is 0.6, y is 0.2, and z is 0.2.

In some examples, including any of the foregoing, the cathode active material is LiNiₓMn_{y}Co_{z}O₂, x is 0.5, y is 0.3, and z is 0.2.

In some examples, including any of the foregoing, the cathode active material is LiNiₓMn_{y}Co_{z}O₂, x is 1/3, y is 1/3, and z is 1/3.

In some examples, including any of the foregoing, the cathode active material is selected from LiMn₂O₄, LiCoO₂, Li(NiCoMn)O₂, and Li(NiCoAl)O₂.

### PROCESS FOR MAKING

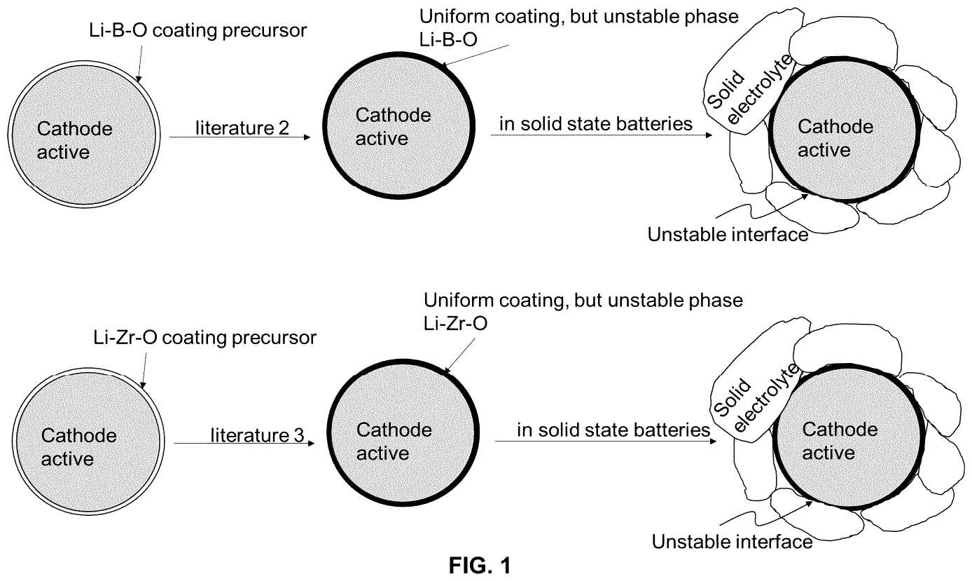

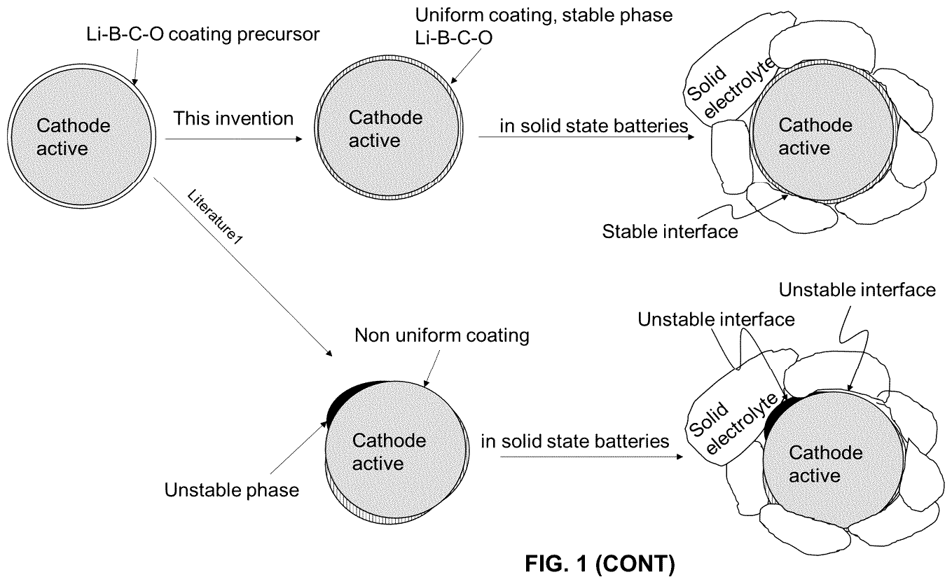

FIG. 1 illustrates some of the differences between certain new methods and compositions disclosed herein and those in the following citations: Literature 1 is Chem. Mater. 2018, 30, 22, 8190-8200,(https://doi.org/10.1021/acs.chemmater.8b03321. Literature 2 is Adv. Energy Mater. 2020, 1903778 (https://doi.org/10.1002/aenm.201903778). Literature 3 is Journal of Power Sources Volume 248, 15 Feb. 2014, Pages 943-950 (https://doi.org/10.1016/j .jpowsour.2013.10.005).

Certain disclosed herein result in more uniform coverage of the cathode active material. This results in a more stable interface between the cathode active material and the solid-state electrolyte which is included in the cathode with the cathode active material.

Also set forth herein is a process for making a coated cathode active material, comprising the following steps: coating a cathode active material with a solution of LiOH; removing the solvent from the solution coating the cathode active material to provide a first material; annealing the first material under dry air conditions to form an annealed first material; coating the annealed first material with a solution of LiOH and a boron source to form a second material; and annealing the second material to form a coated cathode active material.

Also set forth herein is a process for making a coated cathode active material, comprising the following steps: coating a cathode active material with a solution of LiOH and a boron source; removing the solvent from the solution coating the cathode active material to provide a coated cathode active material; and annealing the coated cathode active material under dry air conditions to form a coated cathode active material.

In some examples, including any of the foregoing, a source of boron includes, but is not limited to H₃BO₃ In some examples, including any of the foregoing, a source of boron includes, but is not limited to a boron-containing compound which is soluble in methanol.

In some examples, including any of the foregoing, a source of LiOH includes, but is not limited to LiOH. In some examples, including any of the foregoing, a source of LiOH includes, but is not limited to a lithium-containing compound which is soluble in methanol.

In some examples, including any of the foregoing, the coating is characterized as having an x-ray powder diffraction (XRD) pattern having peaks at 18.9, 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern having peaks at least at 21.4, 30.3, and 31.7 when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, and 37.2, when measured using Cu (Kα) radiation at 25° C.

In some examples, including any of the foregoing, the coating is characterized as having an x-ray powder diffraction (XRD) pattern having peaks at least at 30.3, 31.7, 33.6, 36.7, and 37.2, when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, and 39.8 when measured using Cu (Kα) radiation at 25° C.

In some examples, including any of the foregoing, the coating is characterized as having an x-ray powder diffraction (XRD) pattern having peaks at least at 18.9, 21.4, 30.3, 31.7, 33.6, 36.7, 37.2, and 39.8 when measured using Cu (Kα) radiation at 25° C.

In some examples, including any of the foregoing, the coating is characterized as having an x-ray powder diffraction (XRD) pattern having peaks at least at 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern having peaks at least at 18.9, 21.4, 30.3, 31.7, 33.6, 36.7, 37.2, 39.8, 44.1, 44.9, and 48.7, when measured using Cu (Kα) radiation at 25° C.

In some examples, including any of the foregoing, the coating is characterized as having an x-ray powder diffraction (XRD) pattern substantially as shown in FIG. 2.

In some examples, including any of the foregoing, the coating is characterized as having an x-ray powder diffraction (XRD) pattern substantially as shown as Example D in FIG. 2.

In some examples, including any of the foregoing, the annealing is at a temperature of at most 350° C. for at least 10 minutes.

In some examples, including any of the foregoing, the annealing is at a temperature of at most 350° C. for at least 10 minutes.

In some examples, including any of the foregoing, the solvent is methanol.

In certain examples, set forth herein is a process for making a coated cathode active material, comprising the following operations: coating a cathode active material with a solution of LiOH; removing the solvent from the solution coating the cathode active material to provide a first material; heating the first material under dry air conditions to form a heated first material; coating the heated first material with a solution of LiOH and a boron source to form a second material; and heating the second material to form a coated cathode active material.

In some examples, including any of the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some examples, including any of the foregoing, the cathode active material is LiNiₓMn_{y}Co_{z}O₂, x+y+z=1, 0≤x≤1, 0≤y≤1, and 0≤z≤1.

In some examples, including any of the foregoing, the cathode active material is LiNiₓMn_{y}Co_{z}O₂, xis 0.8, y is 0.1, and z is 0.1.

In some examples, including any of the foregoing, the cathode active material is LiNiₓMn_{y}Co_{z}O₂, x is 0.6, y is 0.2, and z is 0.2.

In some examples, including any of the foregoing, the cathode active material is LiNiₓMn_{y}Co_{z}O₂, x is 0.5, y is 0.3, and z is 0.2.

In some examples, including any of the foregoing, the cathode active material is LiNiₓMn_{y}Co_{z}O₂, x is 1/3, y is 1/3, and z is 1/3.

In some examples, including any of the foregoing, the cathode active material is selected from LiMn₂O₄, LiCoO₂, Li(NiCoMn)O₂, and Li(NiCoAl)O₂.

In certain examples, set forth herein is a process for making a coated cathode active material, comprising the following operations: coating a cathode active material with a solution of LiOH and a boron source; removing the solvent from the solution coating the cathode active material to provide a coated cathode active material; and heating the coated cathode active material under dry air conditions to form a coated cathode active material.

In some examples, including any of the foregoing, the heating is at a temperature of at most 350° C. for at least 10 minutes.

In some examples, including any of the foregoing, the heating is at a temperature of at most 350° C. for at least 10 minutes.

In some examples, including any of the foregoing, the solvent is methanol.

In some examples, including any of the foregoing, the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

In some examples, including any of the foregoing, the cathode active material is LiNiₓMn_{y}Co_{z}O₂, x+y+z=1, 0≤x≤1, 0≤y≤1, and 0≤z≤1.

In some examples, including any of the foregoing, the cathode active material is LiNiₓMn_{y}Co_{z}O₂, x is 0.8, y is 0.1, and z is 0.1.

In some examples, including any of the foregoing, the cathode active material is LiNiₓMn_{y}Co_{z}O₂, x is 0.6, y is 0.2, and z is 0.2.

In some examples, including any of the foregoing, the cathode active material is LiNiₓMn_{y}Co_{z}O₂, x is 0.5, y is 0.3, and z is 0.2.

In some examples, including any of the foregoing, the cathode active material is LiNiₓMn_{y}Co_{z}O₂, x is 1/3, y is 1/3, and z is 1/3.

In some examples, including any of the foregoing, the cathode active material is selected from LiMn₂O₄, LiCoO₂, Li(NiCoMn)O₂, and Li(NiCoA1)O_{2.}

### EXAMPLES

Reagents, chemicals, and materials were commercially purchased unless specified otherwise to the contrary.

Pouch cell containers were purchased from Showa Denko.

The Electrochemical potentiostat used was an Arbin potentiostat.

Electrical impedance spectroscopy (EIS) was performed with a Biologic VMP3, VSP, VSP-300, SP-150, or SP-200.

Electron microscopy was performed in a FEI Quanta SEM, a Helios 600i, or a Helios 660 FIB -SEM.

Transmission Electron microscopy was performed as follows.

Sample preparation: The samples for TEM measurements were prepared using Ga ion sourced focused ion beam (nanoDUE'T NB5000, Hitachi High-Technologies). To protect the surface of material from the Ga ion beam, multiple protective layers were deposited in advance to the sampling; at first, metal layer was deposited by plasma coater and then carbon protective layer and tungsten layer were deposited by high vacuum evaporation and focused ion beam, respectively. The thin slice sampling was conducted by focused ion beam. The prepared sample was measured in TEM.

TEM measurement: TEM images of coated NMC were obtained by field emission electron microscope (JEM-2100F, JEOL). The Acceleration voltage was set to 200 kV. The electron beam radius was set to about 0.7 to 1 nm.

X-ray powder diffraction (XRD) was performed in a Bruker D8 Advance A25 with Cu K-α radiation at room temperature (e.g., between 21° C. and 23° C.). Source is Cu-Ka, wavelength at 1.54 Å. X-ray at 40.kV and 25 mA. Detector: LYNXEYE_XE with PSD opening 2.843. Divergence slit at 0.6 mm and antiscatter at 5.0 mm fixed.

Milling was performed using a Retsch PM 400 Planetary Ball Mill. Mixing was performed using a Fischer Scientific vortex mixer, a Flaktek speed mixer, or a Primix filmix homogenizer.

Casting was performed on a TQC drawdown table. Calendering was performed on an IMC calender.

Light scattering was performed on a Horiba, model: Partica, Model No.: LA-950V2, general term: laser scattering particle size distribution analyzer.

The Lithium Nickel Cobalt Manganese Oxide (NMC) used in the Examples was LiNi_{0.85}Co_{0.1}Mn_{0.05}O₂ unless specified otherwise.

### Example 1—Preparation of NMC Coated With Li₃BO₃ and Annealed at 250° C.

Step 1: Coating Solution Preparation

A coating solution was prepared by combining 0.600 g of LiOH (Spectrum Chemical) with 0.515 g of H₃BO₃ (Sigma) into 400 g of methanol (Sigma). This mixture was stirred for twelve hours at 45° C. in an argon (Ar) filled glovebox (H₂O<0.1 ppm, O₂<0.1 ppm).

Step 2: Coating Step

Lithium Nickel Cobalt Manganese Oxide (NMC) powder (purchased from BASF) (40 g) was put into the solution prepared in step 1 (400 g) and stirred for 0.5 hours. After stirring, the powder was dried using a rotary evaporator at 65° C. to remove the solution.

Step 3: Annealing Step

The powder obtained from step 2 was heated under dry air at 250° C. for 1 hour. This resulted in the coated cathode material.

See FIG. 2 for an XRD pattern of the coated cathode material.

### Example 2—Preparation of NMC Coated With Li₂CO₃ and Li₃BO₃ and Annealed at 250° C.

Step 1: Coating Solution Preparation

A coating solution was prepared by placing 0.07 g of LiOH (Spectrum Chemical) in 400 g of methanol (Sigma). This mixture was stirred for 12 hours at 45° C. in an Ar filled glovebox (H₂O<0.1 ppm, O₂<0.1 ppm).

Step 2: Coating Step

Lithium Nickel Cobalt Manganese Oxide (NMC) powder (purchased from BASF) (40 g) was put into the solution prepared in step 1 (400 g) and stirred for 0.5 hours. After stirring, the power was dried using a rotary evaporator at 65° C. to remove the solution.

Step 3: Annealing Step

The powder obtained from step 2 was heated under dry air at 250° C. for 1 hour. This resulted in a coated cathode material having a first coating of Li₂CO₃ in contact with the active material.

The powder obtained from precursor solution in step 1 was also heated at 250° C. for 1 hour so its x-ray diffraction pattern could be observed.

See FIG. 2 for an XRD pattern of the coated cathode material.

Step 4: Coating Solution Preparation

A coating solution was prepared by combining 0.194 g of LiOH (Spectrum Chemical) with 0.167 g of H₃BO₃ (Sigma) into 400 g of methanol (Sigma). This mixture was stirred for 12 hours at 45° C. in an Ar filled glovebox (H₂O<0.1 ppm, O₂<0.1 ppm).

Step 5: Coating Step

The Li₂CO₃-coated Lithium Nickel Cobalt Manganese Oxide (NMC) powder (prepared in step 3) (40 g), from step 3, was put into the solution prepared in step 4 (400 g) and stirred for 0.5 hours. After stirring, the powder was dried using a rotary evaporator at 65° C. to remove the solution.

Step 6: Annealing Step

The powder obtained from step 5 was heated under dry air at 250° C. for 1 hour. This resulted in a coated cathode material having a first coating of Li₂CO₃ in contact with the active material and a second coating of Li₃BO₃ in contact with the first coating.

The powder obtained from precursor solution in step 1 was also heated at 250° C. for 1 hour so its x-ray diffraction pattern could be observed.

See FIG. 2 for an XRD pattern of the coated cathode material.

### Example 3—Preparation of NMC Coated With LZO/Li₃BO₃ and Annealed at 250° C.

Step 1: Coating Solution Preparation

A coating solution was prepared by placing 0.10 g of LiOH (Spectrum Chemical) and Zirconium butoxide 80% solution (sigma) 0.96 mL in 400 g of ethanol (Sigma). This mixture was stirred for twelve hours at 45° C. in an Ar filled glovebox (H₂O<0.1 ppm, O₂<0.1 ppm).

Step 2: Coating step

Lithium Nickel Cobalt Manganese Oxide (NMC) powder (purchased from BASF) (40 g) was put into the solution prepared in step 1 (400 g) and stirred for 0.5 hours, follow by adding DI water (0.11 mL). The solution was stirred for another 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having a first coating of LZO in contact with the active material.

The powder obtained from the precursor solutions in step 1 and 2 was also heated at 375° C. for 1 hour so its x-ray diffraction pattern could be observed.

Step 4: Coating Solution Preparation

A coating solution was prepared by combining 0.285 g of LiOH (Spectrum Chemical) with 0.25 g of H₃BO₃ (Sigma) into 400 g of methanol (Sigma). This mixture was stirred for 12 hours at 45° C. in an Ar filled glovebox (H₂O<0.1 ppm, O₂<0.1 ppm).

Step 5: Coating step

The LZO-coated Lithium Nickel Cobalt Manganese Oxide (NMC) powder (prepared in step 3) (40 g) was put into the solution prepared in step 4 (400 g) and stirred for 0.5 hours. After stirring, the powder was dried using a rotary evaporator at 65° C. to remove the solution.

Step 6: Annealing Step

The powder obtained from step 5 was heated under dry air at 250° C. for 1 hour. This resulted in a coated cathode material having a first coating of LZO in contact with the active material and a second coating of Li₃BO₃ (LBO) in contact with the first coating.

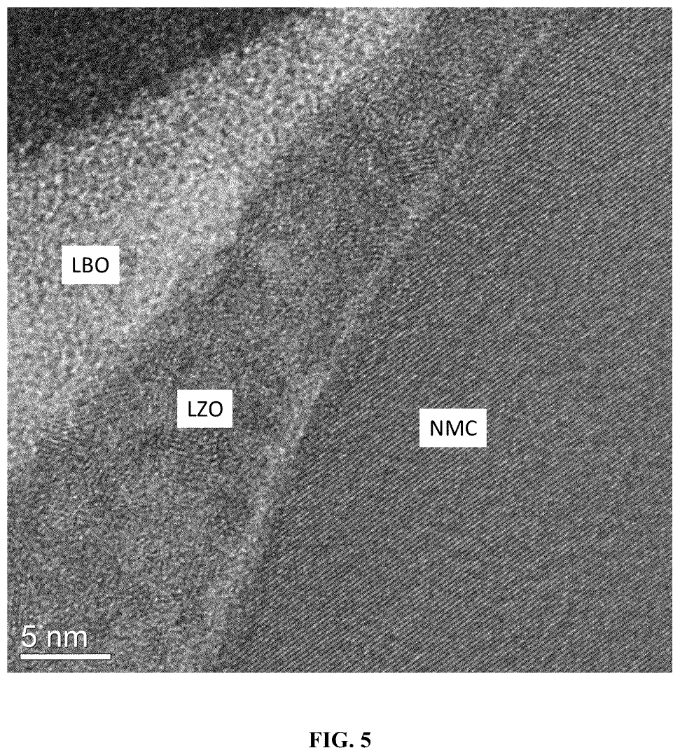

Transmission electron microscope shows clear two layers of LZO/LBO on the top of NMC. See FIG. 5.

### Example 4—Preparation of NMC Coated With LZO/Li₃PO₄ Using Solid-State Reaction and Annealed at 375° C.

Step 1: Coating Solution Preparation

A coating solution was prepared by placing 0.10 g of LiOH (Spectrum Chemical) and Zirconium butoxide 80% solution (sigma) 0.96 mL in 400 g of ethanol (Sigma). This mixture was stirred for 12 hours at 45° C. in an Ar filled glovebox (H₂O<0.1 ppm, O₂<0.1 ppm).

Step 2: Coating Step

Lithium Nickel Cobalt Manganese Oxide (NMC) powder (purchased from BASF) (40 g) was put into the solution prepared in step 1 (400 g) and stirred for 0.5 hours, follow by adding 0.11 milliliters (mL) DI water. The solution was stirred for another 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having a first coating of LZO in contact with the active material.

Step 4: Solid-State Reaction

A secondary coating layer was prepared with a solid-state reaction. The powders obtained by step 3 was mixed with 0.173 g of NH₄H₂PO₄ for 10 min in an agate mortar in an Ar filled Glove box.

Step 5: Annealing Step

The powder obtained from step 4 was heated under dry air at 250° C. for 1 hour. This resulted in a coated cathode material having a first coating of LZO in contact with the active material and a second coating of Li₃PO₄ (LPO) in contact with the first coating.

### Example 5—Preparation of NMC Coated With LZO/Li₃PO₄ Using a Solid-State Reaction at Higher Concentration Than Example 4 and Annealed at 375° C.

Step 1: Coating Solution Preparation

A coating solution was prepared by placing 0.10 g of LiOH (Spectrum Chemical) and Zirconium butoxide 80% solution (sigma) 0.96 mL in 400 g of ethanol (Sigma). This mixture was stirred for 12 hours at 45° C. in an Ar filled glovebox (H₂O<0.1 ppm, O₂<0.1 ppm).

Step 2: Coating Step

Lithium Nickel Cobalt Manganese Oxide (NMC) powder (purchased from BASF) (40 g) was put into the solution prepared in step 1 (400 g) and stirred for 0.5 hours, follow by adding distilled water (DI) water 0.11 mL.

The solution was stirred for another 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having a first coating of LZO in contact with the active material.

Step 4: Coating Solution Preparation

Secondary coating layer was prepared with solid state reaction. The powders obtained by step 3 was mixed with 0.345 g of NH₄H₂PO₄ for 10 min in an agate mortar in an Ar filled Glove box.

Step 5: Annealing Step

The powder obtained from step 4was heated under dry air at 250° C. for 1 hour. This resulted in a coated cathode material having a first coating of LZO in contact with the active material and a second coating of Li₃PO₄ in contact with the first coating.

### Example 6—Preparation of NMC Coated With Li₃BO₃/Li₂SO₄ and Annealed at 250° C.

Step 1: Coating solution preparation

A coating solution was prepared by combining 0.285 g of LiOH (Spectrum Chemical) with 0.25 g of H₃BO₃ (Sigma) into 400 g of methanol (Sigma). This mixture was stirred for 12 hours at 45° C. in an Ar filled glovebox (H₂O<0.1 ppm, O₂<0.1 ppm).

Stoichiometric amounts of distilled water was added to the solution. The solution was dried to get powder precursors.

Step 2: Coating Step

Lithium Nickel Cobalt Manganese Oxide (NMC) powder (purchased from BASF) (40 g) was put into the solution prepared in step 1 (400 g) and stirred for 0.5 hours. After stirring, the powder was dried using a rotary evaporator at 65° C. to remove the solution.

Step 3: Annealing Step

The powder obtained from step 2 was heated under clean dry air at 250° C. for 1 hour. This resulted in a coated cathode material having a first coating of Li₃BO₃ in contact with the active material.

Step 4: Coating Solution Preparation

A coating solution was prepared by putting 0.02 mL of H₂SO₄ (95%, aqueous) into 400 g of ethanol (Sigma). This mixture was stirred for 12 hours at 20° C. in an Ar filled glovebox (H₂O<0.1 ppm, O₂<0.1 ppm).

Step 5: Coating Step

The Li₃BO₃-coated Lithium Nickel Cobalt Manganese Oxide (NMC) powder (prepared in step 3) (40 g) was put into the solution prepared in step 4 (400 g) and stirred for 0.5 hours. After stirring, the powder was dried using a rotary evaporator at 65° C. to remove the solution.

Step 6: Annealing Step

The powder obtained from step 5 was heated under dry air at 250° C. for 1 hour. This resulted in a coated cathode material having a first coating of Li₃BO₃ in contact with the active material and a second coating of Li₂SO₄ in contact with the first coating.

### Example 7—Preparation of NMC Coated With Li₂CO₃/Li₂SO₄ and Annealed at 250° C.

Step 1: Coating Solution Preparation

A coating solution was prepared by combining 0.1 g of LiOH (Spectrum Chemical) into 400 g of methanol (Sigma). This mixture was stirred for 12 hours at 45° C. in an Ar filled glovebox (H₂O<0.1 ppm, O₂<0.1 ppm).

Stoichiometric amounts of distilled water was added to the solution. The solution was dried to get powder precursors.

Step 2: Coating Step

Lithium Nickel Cobalt Manganese Oxide (NMC) powder (purchased from BASF) (40 g) was put into the solution prepared in step 1 (400 g) and stirred for 0.5 hours. After stirring, the powder was dried using a rotary evaporator at 65° C. to remove the solution.

Step 3: Annealing Step

The powder obtained from step 2 was heated under clean dry air at 250° C. for 1 hour. This resulted in a coated cathode material having a first coating of Li₂CO₃ in contact with the active material.

Step 4: Coating Solution Preparation

A coating solution was prepared by putting 0.02 mL of H₂SO₄ (95%, aqueous) into 400 g of ethanol (Sigma). This mixture was stirred for 12 hours at 20° C. in an Ar filled glovebox (H₂O<0.1 ppm, O₂<0.1 ppm).

Step 5: Coating Step

The Li₃BO₃-coated Lithium Nickel Cobalt Manganese Oxide (NMC) powder (prepared in step 3) (40 g) was put into the solution prepared in step 4 (400 g) and stirred for 0.5 hours. After stirring, the powder was dried using a rotary evaporator at 65° C. to remove the solution.

Step 6: Annealing Step

The powder obtained from step 5 was heated under dry air at 250° C. for 1 hour. This resulted in a coated cathode material having a first coating of Li₂CO₃ in contact with the active material and a second coating of Li₂SO₄ in contact with the first coating.

### Example 8—Preparation of NMC Coated With LZO/Li₃PO₄ Using an Acid Treatment, at High Concentration, and Annealed at 375° C.

Step 1: Coating Solution Preparation

A coating solution was prepared by placing 0.10 g of LiOH (Spectrum Chemical) and Zirconium butoxide 80% solution (sigma) 0.96 mL in 400 g of ethanol (Sigma). This mixture was stirred for 12 hours at 45° C. in an Ar filled glovebox (H₂O<0.1 ppm, O₂<0.1 ppm).

Stoichiometric amounts of distilled water was added to the solution. The solution was dried to get powder precursors.

Step 2: Coating Step

Lithium Nickel Cobalt Manganese Oxide (NMC) powder (purchased from BASF) (40 g) was put into the solution prepared in step 1 (400 g) and stirred for 0.5 hours, follow by adding DI water 0.11 mL. The solution was stirred for another 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having a first coating of LZO in contact with the active material.

Step 4: Coating Solution Preparation

A coating solution was prepared by putting 0.2 mL of H₃PO₄ (85%, aqueous) into 400 g of ethanol (Sigma). This mixture was stirred for 12 hours at 20° C. in an Ar filled glovebox (H₂O<0.1 ppm, O₂<0.1 ppm).

Step 5: Coating Step

The LZO-coated Lithium Nickel Cobalt Manganese Oxide (NMC) powder (prepared in step 3) (40 g) was put into the solution prepared in step 5 (400 g) and stirred for 0.5 hours. After stirring, the powder was dried using a rotary evaporator at 65° C. to remove the solution.

Step 6: Annealing Step

The powder obtained from step 5 was heated under dry air at 250° C. for 1 hour. This resulted in a coated cathode material having a first coating of LZO in contact with the active material and a second coating of Li₃PO₄ in contact with the first coating.

### Example 9—Preparation of NMC Coated With LZO/Li₃PO₄ Using an Acid Treatment, at Low Concentration, and Annealed at 375° C.

Step 1: Coating Solution Preparation

A coating solution was prepared by placing 0.10 g of LiOH (Spectrum Chemical) and Zirconium butoxide 80% solution (sigma) 0.96 mL in 400 g of ethanol (Sigma). This mixture was stirred for 12 hours at 45° C. in an Ar filled glovebox (H₂O<0.1 ppm, O₂<0.1 ppm).

Stoichiometric amounts of distilled water was added to the solution. The solution was dried to get powder precursors.

Step 2: Coating Step

Lithium Nickel Cobalt Manganese Oxide (NMC) powder (purchased from BASF) (40 g) was put into the solution prepared in step 1 (400 g) and stirred for 0.5 hours, follow by adding DI water 0.11 mL. The solution was stirred for another 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having a first coating of LZO in contact with the active material.

Step 4: Coating Solution Preparation

A coating solution was prepared by putting 0.02 mL of H3PO₄ (85%, aqueous) into 400 g of ethanol (Sigma). This mixture was stirred for 12 hours at 20° C. in an Ar filled glovebox (H₂O<0.1 ppm, O₂<0.1 ppm).

Step 5: Coating Step

The LZO-coated Lithium Nickel Cobalt Manganese Oxide (NMC) powder (prepared in step 3) (40 g) was put into the solution prepared in step 5 (400 g) and stirred for 0.5 hours. After stirring, the powder was dried using a rotary evaporator at 65° C. to remove the solution.

Step 6: Annealing Step

The powder obtained from step 5 was heated under dry air at 250° C. for 1 hour. This resulted in a coated cathode material having a first coating of LZO in contact with the active material and a second coating of Li₃PO₄ in contact with the first coating.

### Example 10—Preparation of NMC Coated With LZO Using a Spray Dryer and Annealed at 375° C.

Step 1: Coating Solution Preparation

A coating solution was prepared by placing 19.45 g of LiOCH₃ and 11.98 g of Zr(OC₃H₇)₄ in 781 g of isopropanol. This mixture was stirred for 12 hours at 25° C. in an Ar filled glovebox (H₂O<0.1 ppm, O₂<0.1 ppm).

Step 2: Coating step

Lithium Nickel Cobalt Manganese Oxide (NMC) powder (purchased from BASF) 500 g was put into the solution prepared in step 1 (781 g) and stirred for 0.5 hours.

The coating was prepared by using a spray drying method. The coating solution was carried and atomized in a hot drying chamber (120° C.), which allowed for the evaporation of the solvent in the solution and the formation of solid particles. N₂ was used as carrier gas to atomize a liquid stream of the coating solution. The liquid stream of the coating solution produces particles which pass through a cyclone and are collected in a holding chamber.

Step 3: Annealing step

The powder obtained from step 3 was heated under clean dry air at 375° C. for 1 hour. This resulted in a coated cathode material having a first coating of LZO in contact with the active material.

### Example 11—Preparation of NMC Coated With LZO and Annealed at 375° C.

Step 1: Coating Solution Preparation

A coating solution was prepared by adding 0.375 g LiOH and 3.57 mL Zirconium butoxide (Zr(OBu)₄) to 1000 mL anhydrous ethanol. The solution was allowed to stir overnight at room temperature under Argon.

Step 2: Coating Step

In a dry room, 150 g of Lithium Nickel Cobalt Manganese Oxide (NMC) powder (purchased from BASF) was added to the coating solution of Step 1. The resulting mixture was allowed to stir for 30 minutes. 0.425 mL of distilled water was added dropwise to solution to initiate the sol-gel reaction. The reaction proceeded under stirring for more than one and a half hours. After stirring stopped, the solution was decanted and the active material dried using a Rotovap at 65° C., using a sonicating water bath.

Step 3: Annealing Step

The powder obtained from step 3 was heated in an alumina or quartz crucible under flowing clean dry air (CDA, 250 sccm) at 375° C. for 1 hour. This resulted in a coated cathode material having a first coating comprising LZO in contact with the active material. An x-ray diffraction pattern of an LZO coating is shown in FIG. 6. Additional amorphous phases may be present in the coating given that an x-ray diffraction pattern primarily provides information about crystalline materials.

### Example 12—Preparation of Solid Electrolytes

A first solid electrolyte was prepared. Li₁₀Si_{0.5}Sn_{0.5}P₂S₁₂ (hereinafter “LSTPS”) was wet milled to produce LSTPS particles having a d₅₀ particle diameter of about 50 nm to 500 nm. In this Example, LSTPS is referred to a compound characterized by the formula Li₁₀Si_{0.5}Sn_{0.5}P₂S₁₂ . See U.S. Pat. Nos. 9,172,114 and 10,535,878, which are herein incorporated by reference in their entirety for all purposes.

A second solid electrolyte was prepared: Lithium sulfide (Li₂S), phosphorus pentasulfide (P₂S₅), and lithium iodide (LiI) were mixed in a predetermined ratio. In one sample, lithium sulfide (Li₂S), phosphorus pentasulfide (P₂S₅), and lithium iodide (Lil) were mixed. The molar ratio of LiI:Li₂S:P₂S₅ was (3 to 4):(0.1 to 1):(0.5 to 1.5). The mixture was placed in a 500 ml zirconia milling jar with 1 mm zirconia milling media at a milling media:powder mass ratio of >7.5. The mixture was agitated in a planetary mill (Retsch PM400, 150 mm revolution radius, 1:2 speed ratio) for sixteen to thirty-six 16-32 hours.

This procedure was performed in an Ar filled glovebox (H₂O<0.1 ppm, O₂<0.1 ppm).

### Example 13—Making a Battery Cell

Battery cell fabrication was performed in an Ar filled glovebox (H₂O<0.1 ppm, O₂<0.1 ppm).

A cathode layer was made by mixing the coated NMC material from one of Examples 1-11 with the first solid electrolyte from Example 12.

An all-solid-state battery was made using a cathode layer mentioned in the preceding paragraph and a separator which was made of the second solid electrolyte from Example 12.

The cathode layer and separator were pressed at 700 MPa to densify the two into a pellet type battery. An aluminum current collector was used adjacent to the cathode layer. A nickel current collector was used adjacent to an anode layer. The anode layer was made of lithium metal. Metallic lithium as anode was plated when the battery cell was charged.

### Example 14—Testing a Battery

This Example tested the stability of the batteries made according to Example 13.

Stability testing was performed in an Ar filled glovebox (H₂O<0.1 ppm, O₂<0.1 ppm).

Battery cells were charged and discharged at 30° C. at the constant current density of 0.4 mA/cm² and within the operation voltage of 3 V to 4.2 V. During discharge, the area-specific resistance (ASR) of the battery cells was obtained by reading voltage drop during relaxation steps. The obtained ASR was named as Ri here.

After cycling at 30° C., the temperature was raised to 60° C. After the temperature stabilized at 60° C., the battery cells were again charged to 4.2V with a current density of 0.4 mA/cm². Battery cells were held at 4.2V for 3 days, then the cells were discharged to 3V.

The battery cells' temperature was lowered to 30° C. The battery cells were charged and discharged between 3 V and 4.2 V and at a current density of 0.4 mA/cm². From this, an ASR (R₂) was determined.

The stability was evaluated by ΔR=R₂−R_{1.}

A battery made using the coated cathode active material of Example 11 was tested as noted in this Example. This battery showed a 30° C. dcASR growth of 15Ωcm².

A battery made using the coated cathode active material of Example 11 was similarly tested as noted in this Example but at −15° C. This battery showed a Electrochemical Impedance Spectroscopy at −15° C. impedance growth of 590Ωcm². The following data was also collected

| Difference in initial | Difference in final | Difference in ASR² |
|---|---|---|
| ASR² from control | ASR² from control | growth from control |
| (ohm*cm²) | (ohm*cm²) | (ohm*cm²) |
| +10 | −730 | −740 |

### Example 15—Preparation of NMC Coated With LZP and Annealed at 375° C.

Step 1: Coating Solution Preparation

A coating solution was prepared by placing 0.031 g of LiOH (Spectrum Chemical), Zirconium butoxide 80% solution (sigma) 1.18 mL and 0.274 g of P₂O₅ (sigma) in 263 g of ethanol (Sigma). This mixture was stirred for 12 hours at 45° C. in an Ar filled glovebox (H₂O<0.1 ppm, O₂<0.1 ppm).

Step 2: Coating Step

Lithium Nickel Cobalt Manganese Oxide (NMC) powder (purchased from BASF) (50 g) was put into the solution prepared in step 1 (263 g) and stirred for 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having LZP coating in contact with the active material. Herein LZP is LiZr₂(PO₄)_{3.}

Transmission electron microscope shows clear two layers of LZP on the top of NMC. See FIG. 8.

### Example 16—Preparation of NMC Coated With LZO/Li₃InCl₆ and Annealed at 250° C.

Step 1: Coating Solution Preparation

A coating solution was prepared by placing 0.10 g of LiOH (Spectrum Chemical) and Zirconium butoxide 80% solution (sigma) 0.96 mL in 400 g of ethanol (Sigma). This mixture was stirred for 12 hours at 45° C. in an Ar filled glovebox (H₂O<0.1 ppm, O₂<0.1 ppm).

Step 2: Coating Step

Lithium Nickel Cobalt Manganese Oxide (NMC) powder (purchased from BASF) (40 g) was put into the solution prepared in step 1 (400 g) and stirred for 0.5 hours, followed by adding deionized water (DI) water (0.11 mL). The solution was stirred for another 1.5 hours. After stirring, the powder was dried using a rotary evaporator at 65° C. to remove the solution.

Step 3: Annealing Step

The powder obtained from step 2 was heated under clean dry air at 375° C. for 1 hour. This resulted in a coated cathode material having a first coating of LZO in contact with the active material.

Step 4: Coating Chemical Preparation

The coating chemical (Li₃InCl₆) was prepared by high energy ball-milling solid-state synthesis. 1.6956 g of LiCl (sigma) and 2.9491 g of InCl₃ (sigma) were loaded into a 125 ml ZrO₂ ball-milling jar with 40 ZrO₂ balls in a diameter of 10 mm in an Ar-filled glovebox (H₂O<0.1 ppm, O₂<0.1 ppm). This mixture was milled at a speed of 1200 rpm for 5 hours with under a controlled temperature no higher than 50° C. using emax (Retsch). The resulting powder was collected in the Ar-filled glovebox, followed by a heat treatment in Ar at 300° C. for 5 hours.

Step 5: Coating Solution Preparation

A coating solution was prepared by combining 0.3479 g of heat treated Li₃InCl₆ (prepared in step 4) into 400 g of methanol (Sigma). This mixture was stirred for 10 minutes at 25 ° C. in ambient air.

Step 6: Coating Step

The Lithium Nickel Cobalt Manganese Oxide (NMC) powder (prepared in step 3) (25 g) was put into the solution prepared in step 5 (400 g) and stirred for 0.5 hours. After stirring, the powder was dried using a rotary evaporator at 65° C. to remove the solution.

Step 7: Annealing Step

The powder obtained from step 6 was heated under vacuum at 250° C. for 10 hours. This resulted in a coated cathode material having a first coating of LZO in contact with the active material and a second coating of Li₃InCl₆ in contact with the first coating. Herein, LZO is Li₂ZrO₃.

### Example 17—Testing a Battery

A series of battery cells were prepared as detailed in Table 1. Table 1 specifies the ratio of starting materials, the mass of coated cathode materials, and the annealing temperature.

TABLE 1

| | | | Precursors for coating solution | | | | | | | |
|---|---|---|---|---|---|---|---|---|---|---|
| | | | | | | | | | 85% | 95% |
| | NMC wt. | Annealing | LiOH | LiOCH₃ | H₃BO₃ | ZrBuOt | Zr(OC₃H₇)₄ | NH₄H₂PO₄ | H₃PO₄ | H₂SO₄ |
| Sample | (g) | T (° C.) | (g) | (g) | (g) | (g) | (g) | (g) | aq(mL) | aq (mL) |
| Example A | 40 | 250 | 0.600 | 0 | 0.515 | 0 | 0 | 0 | 0 | 0 |
| Example B | 80 | 200 | 0.600 | 0 | 0.515 | 0 | 0 | 0 | 0 | 0 |
| Example C | 40 | 350 | 0.600 | 0 | 0.515 | 0 | 0 | 0 | 0 | 0 |
| Example D | 40 | 250 | 0.07 | 0 | 0 | 0 | 0 | 0 | 0 | 0 |
| | 40 | 250 | 0.194 | 0 | 0.167 | 0 | 0 | 0 | 0 | 0 |
| Comparative | 40 | 600 | 0.600 | 0 | 0.515 | 0 | 0 | 0 | 0 | 0 |
| Example E | | | | | | | | | | |
| Comparative | 40 | 350 | 0.296 | 0 | 2.805 | 0 | 0 | 0 | 0 | 0 |
| Example F | | | | | | | | | | |
| Comparative | 40 | 375 | 0.374 | 0 | 0 | 3.569 | 0 | 0 | 0 | 0 |
| Example G | | | | | | | | | | |
| Example 3 | 40 | 375 | 0.1 | 0 | 0 | 0.95 | 0 | 0 | 0 | 0 |
| | | 250 | 0.285 | 0 | 0.25 | 0 | 0 | 0 | 0 | 0 |
| Example 4 | 40 | 375 | 0.1 | 0 | 0 | 0.95 | 0 | 0 | 0 | 0 |
| | | 250 | 0 | 0 | 0 | 0 | 0 | 0.173 | 0 | 0 |
| Example 5 | 40 | 375 | 0.1 | 0 | 0 | 0.95 | 0 | 0 | 0 | 0 |
| | 40 | 250 | 0 | 0 | 0 | 0 | 0 | 0.345 | 0 | 0 |
| Example 6 | 40 | 250 | 0.285 | 0 | 0.25 | 0 | 0 | 0 | 0 | 0 |
| | 40 | 250 | 0 | 0 | 0 | 0 | 0 | 0 | 0 | 0.02 |
| Example 7 | 40 | 250 | 0.1 | 0 | 0 | 0 | 0 | 0 | 0 | 0 |
| | 40 | 250 | 0 | 0 | 0 | 0 | 0 | 0 | 0 | 0.02 |
| Example 8 | 40 | 375 | 0.1 | 0 | 0 | 0.95 | 0 | 0 | 0 | 0 |
| | 40 | 250 | 0 | 0 | 0 | 0 | 0 | 0 | 0.2 | 0 |
| Example 9 | 40 | 375 | 0.1 | 0 | 0 | 0.95 | 0 | 0 | 0 | 0 |
| | 40 | 250 | 0 | 0 | 0 | 0 | 0 | 0 | 0.02 | 0 |
| Example 10 | 500 | 375 | 0 | 19.45 | 0 | 0 | 11.98 | 0 | 0 | 0 |

In Table 1, above, Examples D, 3, 4, 5, 6, 7, 8, 9, and 10 were run, separately, at two different temperatures. This is indicated by the double rows in Table 1, above, next to these Examples.

Herein, the difference between Example A and Example E is the annealing temperature.

Example B—Li₃BO₃ heated at 200° C. Made according to Table 1 and Example 1.

Example C—Li₃BO₃ heated at 350° C. Made according to Table 1 and Example 1.

Example D—Li₂CO₃—Li₃BO₃ dual coating heated at 250° C. Made according to Table 1 and Example 2.

Comparative Example E—Li₃BO₃ heated at 600° C. Made according to Table 1 and Example 1 except that it was heated at 600° C. not 250° C., as in Example 1. Example E is a reproduction of a synthesis in Chem. Mater. 2018, 30, 22, 8190-8200, (https://doi.org/10.102/acs.chemmater.8b03321.

Comparative Example F—Li₃B₁₁O₁₈ heated at 350° C. Made according to Table 1 and Example 1 except that it was heated at 350° C. not 250° C., as in Example 1. Example F is a reproduction of Adv. Energy Mater. 2020, 1903778 (https://doi.org/10.1002/aenm.201903778).

Comparative Example G—LZO heated at 375° C. Made according to Table 1 heated in dry air at 375° C. Example G is a reproduction of Journal of Power Sources, Volume 248, 15 Feb. 2014, Pages 943-950 (https://doi.org/10.1016/j.jpowsour.2013.10.005).

The results herein, (e.g., Examples 3) demonstrate that the stability of the cathode active material was dramatically improved when a layer of LiBO₃ was added on top of a layer of LZO; when compared to an uncoated cathode active material. See, for example, comparative example G.

The results herein (e.g., Example 10, spray dried LZO) demonstrate that the stability of the cathode active material was improved when LZO was spray dried onto the cathode active material as compared to when the LZO was applied using sol-gel coating techniques and rotary evaporation. See comparative Example 10. The spray dryer may in some instances result in a more uniform coating. For dual coating applications, spray drying may advantageous.

The results herein (e.g., Examples 3, 8) demonstrate that the stability performance of the dual coating depends on the process by which it is made.

### Stability test results

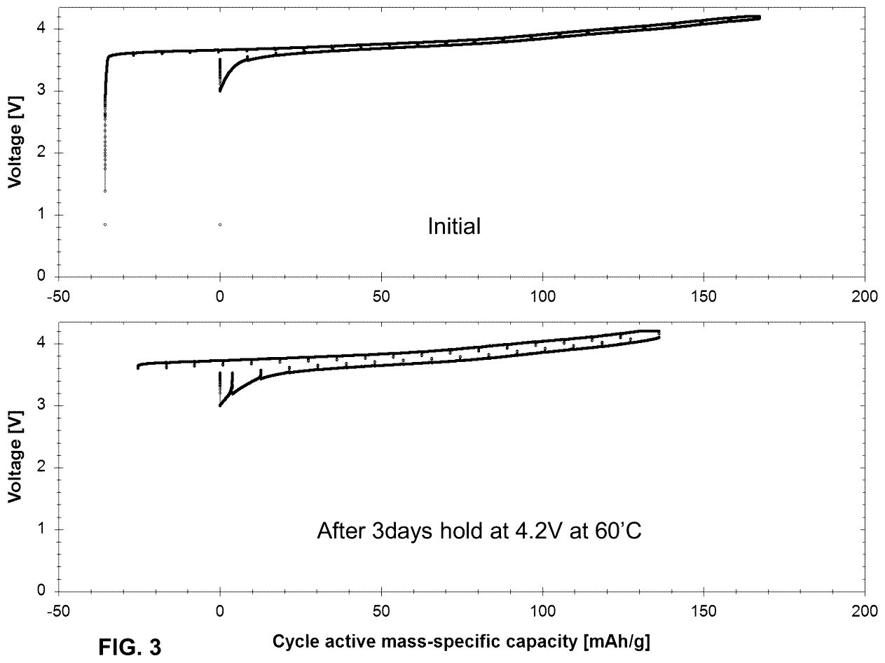

FIG. 3 shows charge and discharge curves of cells in Example 14.

Examples A, B, C, and D show a smaller polarization at the 4.2V hold at 60° C. for 3 days than those of the comparative examples. This indicates greater stability of Examples A, B, C, and D, compared to Comparative Examples E, F, and G

ΔR is an indicator of stability.

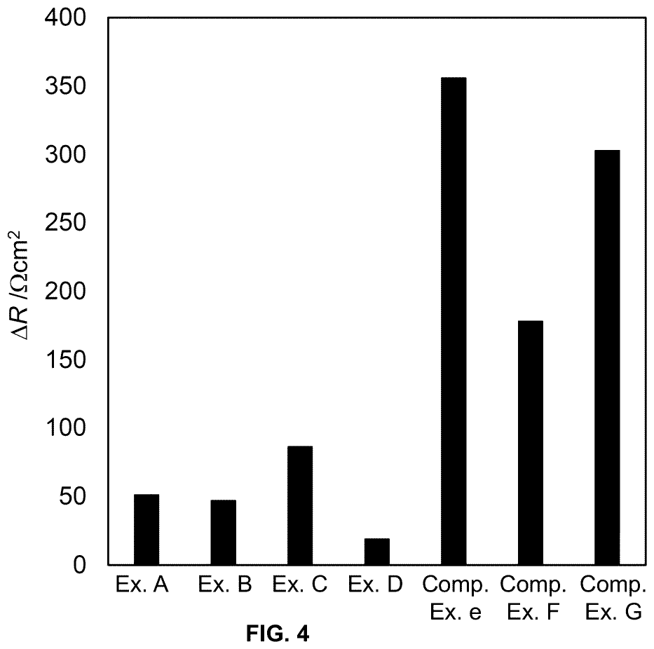

ΔR values are shown in FIG. 4.

Cell resistance values are listed in Table 2, below.

In the Examples A, B, C, and D, the ΔR values ranged from 19 to 86.

In Comparative Examples E, F, and G, the ΔR values ranged from 178 to 356.

### X-ray Diffraction (XRD)

The powder from step 1 of Example 1 was obtained and heated at different temperatures.

FIG. 2 is the XRD patterns of Example A, B, C, D and Comparative Example E.

Comparative Example E is a reproduction of the Li₃BO₃—Li₂CO₃ material in Chem. Mater. 2018, 30, 22, 8190-8200. In Chem. Mater. 2018, 30, 22, 8190-8200, the material was heated at 600° C. This high temperature cause shrinkage of the coating layer and non-uniform coverage. In addition, unstable phases were observed after high temperature annealing. These unstable phases resulted in poor stability.

The difference between Examples A, B, and C and Comparative Example E are the following.

The peak width of the main phase of the new embodiment is much broader than literature condition. This peak width indicates more amorphous material and/or a less dense state. This amorphous material and/or a less dense state is preferred for uniform coatings. For example, if a coating is too crystalline, there could be a densification of the coating and this would result in less coverage.

The peak intensity difference varies with annealing temperature. This is due to the difference in the ratio of Li₃BO₃ and Li₂CO₃ in the coating chemistry.

The peak intensity ratio (k) at 30.3 degree (2Θ) and 31.7 degree (2Θ) is as follows: k=I (30.3)/I (31.7)>1 for the new embodiment. k<1 in Chem. Mater. 2018, 30, 22, 8190-8200.

k indicates the ratio of Li₃BO₃ and Li₂CO₃. The larger k, the more Li₃BO₃.

Example A was observed to have a k value of 1.85.

Example B was observed to have a k value of 1.25.

Example C was observed to have a k value of 1.27.

Comparative Example E was observed to have a k value of 0.89.

This is an indication of a more stable phase and better coverage for Examples A, B, and C, as compared to Comparative Example E.

Comparative Example F used the Li₃B₁₁O₁₈ material from Adv. Energy Mater. 2020, 1903778. This material has a low lithium content which results in high ASR.

Comparative Example G is a reproduction of the Li₂O—ZrO₂ material from Journal of Power Sources 248, 2014, 943-950. Due to poor stability of the Li—Zr—O system, batteries that use this material are observed to have a high ASR which increases when at a charged state.

Comparative Examples F and G show higher ΔR than each of Examples A, B, C, or D. This is likely due to Li₃B₁₁O₁₈ and Li₂ZrO₃, which are less stable than Examples A, B, C, or D.

Referring to FIG. 2, the main phase identified is a phase comprising Li, B, C and O. This is marked with diamonds in FIG. 2.

The crystallinity increased as the annealing temperature increased.

At 600° C. (Comparative Example E; made according to Chem. Mater. 2018, 30, 22, 8190-8200,(https://doi.org/10.1021/acs.chemmater.8b03321)), the material was a highly crystalline phase of Li—B—C—O with secondary phases also present.

Poor stability was shown in stability test for Comparative Example E. This indicates that secondary phases may not be stable. Too much crystallinity may cause densification of the coating (because of the higher density of crystals compared to amorphous material) and result in a non-uniform coating.

The crystallinity decreased as the annealing temperature decreased. The lower density of amorphous materials may result in a more uniform coating. Also, less secondary phases were observed at lower annealing temperature as compared to Comparative Example E.

TABLE 2

| Sample | R1/Ωcm² | R2/Ωcm² | ΔR/Ωcm² |
|---|---|---|---|
| Example A | 40 | 91 | 51 |
| Example B | 57 | 104 | 47 |
| Example C | 45 | 131 | 86 |
| Example D | 32 | 51 | 19 |
| Comparative Example E | 54 | 410 | 356 |
| Comparative Example F | 59 | 237 | 178 |
| Comparative Example G | 36 | 339 | 303 |
| Example 3 | 42 | 60 | 18 |
| Example 4 | 79 | 226 | 147 |
| Example 5 | 76 | 385 | 309 |
| Example 6 | 61 | — | — |
| Example 7 | — | — | — |
| Example 8 | — | — | — |
| Example 9 | 97 | 383 | 286 |
| Example 10 | 53 | 219 | 166 |
| Example 15 | 28 | 53 | 25 |
| Example 16 | 69 | 96 | 27 |

The embodiments and examples described above are intended to be merely illustrative and non-limiting. Those skilled in the art will recognize or will be able to ascertain using no more than routine experimentation, numerous equivalents of specific compounds, materials and procedures. All such equivalents are considered to be within the scope and are encompassed by the appended claims.

What is claimed is:

1. A composition comprising:
a cathode active material; and a
coating in contact with the cathode active material, wherein:
the coating comprises lithium, carbon, oxygen, zirconium, phosphorus, or a combination thereof;
the coating is amorphous based on x-ray diffraction pattern analysis;
the coating comprises crystalline domains based on transmission electron microscopy (TEM) analysis.

2. The composition of claim 1, wherein the coating has the chemical formula:
LiₓZr_{y}O_{z}, wherein 0≤x≤1.6, 0.2≤y≤1.0, and 2≤z≤1.2;
LiₓP_{y}O_{z}, wherein 0.6≤x≤1.5, 0.5≤y≤1.4, and 2.0≤z≤3.7;
LiₓZr_{y}(PO₄)_{z}, wherein 0.05≤x≤1.5, 1≤y≤3, and 2.0≤z≤4.0; or
LiₓC_{y}O_{z}, wherein 0.4≤x≤1.8, 0.1≤y≤1, and 1≤z≤1.8.

3. The composition of claim 1-2, wherein the coating further comprises amorphous domains based on TEM analysis in addition to the crystalline domains based on transmission electron microscopy analysis.

4. The composition of claim 3, wherein the crystalline domains are in contact with the cathode active material.

5. The composition of claim 4, wherein the amorphous domains are not in contact with the cathode active material.

6. The composition of any one of claims 1-5, wherein the coating has a thickness, T, as determined by TEM analysis, that is 1 nm≤T≤20 nm.

7. The composition of claim 82, wherein T is about 1, about 5 nm, or about 10 nm.

8. The composition of any one of claims 1-5, wherein the coating crystalline domains do not lattice match the crystalline domains of the cathode active material, as determined by TEM analysis.

9. The composition of any one of claims 1-8, further comprising a second coating in contact with the coating.

10. The composition of claim 9, wherein the second coating has a chemical formula which is not the same as the chemical formula of the coating.

11. The composition of any one of claims 9-10, wherein the second coating has the chemical formula:
LiₓB_{y}O_{z}, wherein 0.2≤x≤0.75, 0.5≤y≤1.6, and 1.5≤z≤2.6; or
LiₓIn_{y}Cl_{z}, wherein 2≤x≤4, 0≤y≤2, and 5≤z≤7.

12. The composition of any one of claims 9-11, wherein the second coating is amorphous as determined by TEM analysis.

13. The composition of any one of claims 9-11, wherein the second coating is crystalline as determined by TEM analysis.

14. The composition of any one of claims 9-13, wherein the second coating is Li₃BO₃.

15. The composition of any one of claims 9-13, wherein the coating is Li₃InCl₆.

16. The composition of any one of claims 9-13, wherein the first coating is LiₓZr_{y}O_{z}, wherein 0≤x≤1.6, 0.2≤y≤1.0, and 2≤z≤1.2.

17. The composition of claim 16, wherein the first coating is a lithium zirconium oxide.

18. The composition of claim 16 or 17, wherein the first coating is a Li₂ZrO₃.

19. The composition of any one of claims 1-18, wherein the first coating is LiₓP_{y}O_{z}, wherein 0.6 ≤x≤1.5, 0.5≤y≤1.4, and 2.0≤z≤3.7.

20. The composition of claim 19, wherein the first coating is Li₃(PO₄).

21. The composition of any one of claims 1-10, wherein the first coating is LiₓZr_{y}(PO₄)_{z}, wherein 0.05≤x≤1.5, 1≤y≤3, and 2.0≤z≤4.0.

22. The composition of claim 21, wherein the first coating is LiZr₂(PO₄)₃

23. The composition of any one of claims 1-10, wherein the coating or the second coating, or both, further comprises a member selected from the group consisting of Li₂CO₃, Li₃BO₃, Li₃B₁₁O₁₈, Li₂ZrO₃, Li₃PO₄, Li₂SO₄, LiNbO₃, Li₄Ti₅O₁₂, LiTi₂(PO₄)₃, LiZr₂(PO₄)₃, LiOH, LiF, Li₄ZrF₈, Li₃Zr₄F₁₉, Li₃TiF₆, LiAlF₄, LiYF₄, LiNbF₆, ZrO₂, Al₂O₃, TiO₂, ZrF₄, AlF₃, TiF₄, YF₃, NbF₅, and combinations thereof.

24. The composition of any one of claims 1-23, wherein the cathode active material is selected from LiMPO₄ (M=Fe, Ni, Co, Mn); LiₓTi_{y}O_{z}, wherein x is from 0 to 8, y is from 1 to 12, z is from 1 to 24; LiMn₂ₐNiₐO₄, wherein a is from 0 to 2; a nickel cobalt aluminum oxide; LiNiₓMn_{y}Co_{z}O₂, x+y+z=1, 0≤x≤1, 0≤y≤1, and 0≤z≤1; and LiNiₓCo_{y}Al_{z}O₂, wherein x+y+z=1, and 0≤x≤1, 0≤y≤1, and 0≤z≤1.

25. The composition of claim 24, wherein the cathode active material is LiNiₓMn_{y}Co_{z}O₂, x+y+z=1, 0≤x≤1, 0≤y≤1, and 0≤z≤1.

26. The composition of claim 24, wherein the cathode active material is LiNiₓMn_{y}Co_{z}O₂, x is 0.8, y is 0.1, and z is 0.1.

27. The composition of claim 24, wherein the cathode active material is LiNiₓMn_{y}Co_{z}O₂, x is 0.6, y is 0.2, and z is 0.2.

28. The composition of claim 24, wherein the cathode active material is LiNiₓMn_{y}Co_{z}O₂, x is 0.5, y is 0.3, and z is 0.2.

29. The composition of claim 24, wherein the cathode active material is LiNiₓMn_{y}Co_{z}O₂, x is 1/3, y is 1/3, and z is 1/3.

30. The composition of claim 24, wherein the cathode active material is selected from LiMn₂O₄, LiCoO₂, Li(NiCoMn)O₂, and Li(NiCoAl)O_{2.}

31. A solid-state cathode comprising the coated cathode active material of any one of claims 1-30.
